(19) United States
(12) Patent Application Publication
(10) Pub. No.: US 2026/0099678 A1
(43) Pub. Date: Apr. 9, 2026

(54) USER-FEEDBACK BASED PROMPT TUNING FOR ARTIFICIAL INTELLIGENCE APPLICATIONS

(71) Applicant: Salesforce, Inc., San Francisco, CA (US)

(72) Inventors: Kiran Ramnath, San Francisco, CA (US); Sitaram Asur, San Francisco, CA (US); Bin Bi, Bellevue, WA (US); Regunathan Radhakrishnan, San Francisco, CA (US); Manjeet Singh, San Francisco, CA (US)

(21) Appl. No.: 18/907,005

(22) Filed: Oct. 4, 2024

(51) Int. Cl. G06F 40/40

(52) U.S. Cl. CPC G06F 40/40

(57) ABSTRACT

A service may receive, from users of an application that uses a prompt for accessing an LLM, a set of feedback indications associated with a set of responses from the LLM based on the prompt including a set of parameters. The service may transmit, to a first LLM, the set of feedback indications and the set of responses to obtain a set of feedback evaluations. The service may transmit, to a second LLM, the set of feedback evaluations to obtain a summary of the set of feedback evaluations. The service may transmit, to a third LLM, the summary of the set of feedback evaluations and the prompt associated with the set of responses to obtain a set of updated parameters for the prompt. The service may then configure the application to use the prompt with the set of updated parameters for accessing the LLM.

### FIELD OF TECHNOLOGY

The present disclosure relates generally to database systems and data processing, and more specifically to user-feedback based prompt tuning for artificial intelligence (AI) applications.

### BACKGROUND

A cloud platform (i.e., a computing platform for cloud computing) may be employed by multiple users to store, manage, and process data using a shared network of remote servers. Users may develop applications on the cloud platform to handle the storage, management, and processing of data. In some cases, the cloud platform may utilize a multi-tenant database system. Users may access the cloud platform using various user devices (e.g., desktop computers, laptops, smartphones, tablets, or other computing systems, etc.).

In one example, the cloud platform may support customer relationship management (CRM) solutions. This may include support for sales, service, marketing, community, analytics, applications, and the Internet of Things. A user may utilize the cloud platform to help manage contacts of the user. For example, managing contacts of the user may include analyzing data, storing and preparing communications, and tracking opportunities and sales.

In some examples, applications utilizing large language models (LLMs) may include prompts that are pre-configured for the application. Moreover, the prompts may be initially generated before any interaction with user data. Thus, the prompts may be generic and untrained for specific tasks for groups of users or tenants. Therefore, administrative users may have to manually train and configure prompts for LLMs which may be time consuming and inefficient. For example, tenants may use a relatively large set of applications utilizing LLM prompts. As such, administrative users may have to manually adjust and perform iterative testing to improve the performance of an LLM prompt for a respective tenant which may result in an increase in latency and delay and a decrease in efficiency, effectiveness, and reliability of the applications utilizing the LLMs.

### BRIEF DESCRIPTION OF THE DRAWINGS

FIG. 1 illustrates an example of a system that supports user-feedback based prompt tuning for artificial intelligence (AI) applications in accordance with aspects of the present disclosure.

FIG. 2 shows an example of a computing system that supports user-feedback based prompt tuning for AI applications in accordance with aspects of the present disclosure.

FIG. 3 shows an example of a system diagram that supports user-feedback based prompt tuning for AI applications in accordance with aspects of the present disclosure.

FIG. 4 shows an example of a process flow that supports user-feedback based prompt tuning for AI applications in accordance with aspects of the present disclosure.

FIG. 5 shows a block diagram of an apparatus that supports user-feedback based prompt tuning for AI applications in accordance with aspects of the present disclosure.

FIG. 6 shows a block diagram of an LLM prompt tuning service that supports user-feedback based prompt tuning for AI applications in accordance with aspects of the present disclosure.

FIG. 7 shows a diagram of a system including a device that supports user-feedback based prompt tuning for AI applications in accordance with aspects of the present disclosure.

FIG. 8 shows a flowchart illustrating methods that support user-feedback based prompt tuning for AI applications in accordance with aspects of the present disclosure.

### DETAILED DESCRIPTION

In some examples, tenants within a multi-tenant system may use applications that utilize large language models (LLMs). In some cases, the applications may utilize the LLMs by executing one or more LLM prompts that includes sets of instructions for the LLM. Further, in some examples, applications may use LLM prompts that are generic and are untrained for respective tenants, applications, or both. For example, an LLM prompt may be initially designed or generated to perform a respective task or to operate within an application before interacting with any real user data. Thus, to ensure that the LLMs of an application generate relatively high quality and reliable responses, system administrators may have to perform one or more adjustments or updates on the LLM prompts to improve the performance of an LLM based on performance metrics. For example, a system administrator may use user data to generate different versions of an LLM prompt and perform tests and experiments to generate an LLM prompt that is specific to the tenant of the system administrator and the application. However, as tenants may use a relatively high quantity of applications utilizing LLMs (e.g., LLM applications), having administrators continuously experiment with different prompt versions for different applications may be impractical and inefficient. Therefore, current techniques of manually adjusting LLM prompts based on user data and user feedback may be inefficient as the quantity of applications that utilize LLMs that tenants use increases. Moreover, a lack of techniques to automatically evaluate and improve prompts of LLMs in real-time may further decrease the overall effectiveness of LLM applications.

The present disclosure describes techniques for automatically fine-tuning LLM prompts based on user-feedback. For example, a system may receive, from a set of users of a first application that uses an application-specific LLM prompt for accessing a target LLM, a set of feedback indications associated with a set of responses from the target LLM based on the application-specific LLM prompt that includes a set of parameters. In response to receiving the feedback indications, the system may transmit the set of feedback indications and the set of responses associated with the set of feedback indications to a first LLM configured to evaluate feedback. The system may then obtain a set of feedback evaluations generated by the first LLM as a result of the transmission of the set of feedback indications. Further, the system may then transmit the set of feedback evaluations obtained from the first LLM to a second LLM configured to generate summaries to obtain a summary of the set of feedback evaluations as a result of the transmission. Moreover, the system may transmit the summary of the set of feedback evaluations and the application-specific LLM prompt to a third LLM configured to fine-tune LLM prompts to obtain a set of updated parameters for the application-specific LLM prompt. Based on obtaining the set of updated parameters, the system may then configure the first application to use the application-specific LLM prompt with the set of updated parameters for accessing the target LLM. Thus, the system may be capable of translating user feedback on responses from an LLM in real-time to generate updated parameters for the LLM to improve the performance of the LLM, the accuracy of the responses, and the reliability of applications that use application-specific LLM prompts for accessing target LLMs.

In some examples, based on configuring the first application to use the set of updated parameters, the system may receive a set of updated responses from the target LLM in accordance with the target LLM being accessed via the application-specific LLM prompt that includes the set of updated parameters. In response, the system may transmit the set of updated responses to the users of the first application. Moreover, as part of the system, each of the LLMs utilized by the system may perform respective training procedures to perform respective tasks. For example, the system may perform a first training procedure on the first LLM to train the first LLM to evaluate feedback that is associated with respective responses from a respective LLM based on a respective LLM prompt, perform a second training procedure on the second LLM to train the second LLM to generate summaries, and perform a third training procedure on the third LLM to train the third LLM to fine-tune LLM prompts associated with applications. Additionally, or alternatively, in some cases, the system may initiate the procedure described herein to fine-tune an application-specific LLM prompt based on one or more thresholds (e.g., performance metric thresholds, quantity of feedback indication thresholds, and the like).

Aspects of the disclosure are initially described in the context of an environment supporting an on-demand database service. Additional aspects of the disclosure are described with reference to a computing system, a system diagram, and a process flow. Aspects of the disclosure are further illustrated by and described with reference to apparatus diagrams, system diagrams, and flowcharts that relate to user-feedback based prompt tuning for artificial intelligence (AI) applications.

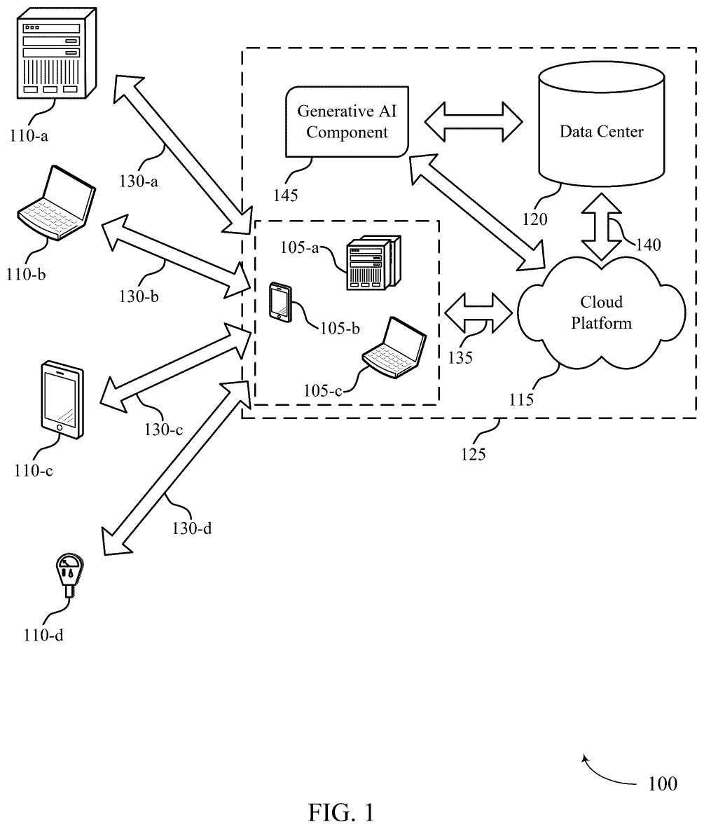

FIG. 1 illustrates an example of a system 100 for cloud computing that supports user-feedback based prompt tuning for AI applications in accordance with various aspects of the present disclosure. The system 100 includes cloud clients 105, contacts 110, cloud platform 115, and data center 120. Cloud platform 115 may be an example of a public or private cloud network. A cloud client 105 may access cloud platform 115 over network connection 135. The network may implement transfer control protocol and internet protocol (TCP/IP), such as the Internet, or may implement other network protocols. A cloud client 105 may be an example of a user device, such as a server (e.g., cloud client 105-a), a smartphone (e.g., cloud client 105-b), or a laptop (e.g., cloud client 105-c). In other examples, a cloud client 105 may be a desktop computer, a tablet, a sensor, or another computing device or system capable of generating, analyzing, transmitting, or receiving communications. In some examples, a cloud client 105 may be operated by a user that is part of a business, an enterprise, a non-profit, a startup, or any other organization type.

A cloud client 105 may interact with multiple contacts 110. The interactions 130 may include communications, opportunities, purchases, sales, or any other interaction between a cloud client 105 and a contact 110. Data may be associated with the interactions 130. A cloud client 105 may access cloud platform 115 to store, manage, and process the data associated with the interactions 130. In some cases, the cloud client 105 may have an associated security or permission level. A cloud client 105 may have access to certain applications, data, and database information within cloud platform 115 based on the associated security or permission level, and may not have access to others.

Contacts 110 may interact with the cloud client 105 in person or via phone, email, web, text messages, mail, or any other appropriate form of interaction (e.g., interactions 130-a, 130-b, 130-c, and 130-d). The interaction 130 may be a business-to-business (B2B) interaction or a business-to-consumer (B2C) interaction. A contact 110 may also be referred to as a customer, a potential customer, a lead, a client, or some other suitable terminology. In some cases, the contact 110 may be an example of a user device, such as a server (e.g., contact 110-a), a laptop (e.g., contact 110-b), a smartphone (e.g., contact 110-c), or a sensor (e.g., contact 110-d). In other cases, the contact 110 may be another computing system. In some cases, the contact 110 may be operated by a user or group of users. The user or group of users may be associated with a business, a manufacturer, or any other appropriate organization.

Cloud platform 115 may offer an on-demand database service to the cloud client 105. In some cases, cloud platform 115 may be an example of a multi-tenant database system. In this case, cloud platform 115 may serve multiple cloud clients 105 with a single instance of software. However, other types of systems may be implemented, including—but not limited to—client-server systems, mobile device systems, and mobile network systems. In some cases, cloud platform 115 may support CRM solutions. This may include support for sales, service, marketing, community, analytics, applications, and the Internet of Things. Cloud platform 115 may receive data associated with contact interactions 130 from the cloud client 105 over network connection 135, and may store and analyze the data. In some cases, cloud platform 115 may receive data directly from an interaction 130 between a contact 110 and the cloud client 105. In some cases, the cloud client 105 may develop applications to run on cloud platform 115. Cloud platform 115 may be implemented using remote servers. In some cases, the remote servers may be located at one or more data centers 120.

Data center 120 may include multiple servers. The multiple servers may be used for data storage, management, and processing. Data center 120 may receive data from cloud platform 115 via connection 140, or directly from the cloud client 105 or an interaction 130 between a contact 110 and the cloud client 105. Data center 120 may utilize multiple redundancies for security purposes. In some cases, the data stored at data center 120 may be backed up by copies of the data at a different data center (not pictured).

Subsystem 125 may include cloud clients 105, cloud platform 115, and data center 120. In some cases, data processing may occur at any of the components of subsystem 125, or at a combination of these components. In some cases, servers may perform the data processing. The servers may be a cloud client 105 or located at data center 120.

The system 100 may be an example of a multi-tenant system. For example, the system 100 may store data and provide applications, solutions, or any other functionality for multiple tenants concurrently. A tenant may be an example of a group of users (e.g., an organization) associated with a same tenant identifier (ID) who share access, privileges, or both for the system 100. The system 100 may effectively separate data and processes for a first tenant from data and processes for other tenants using a system architecture, logic, or both that support secure multi-tenancy. In some examples, the system 100 may include or be an example of a multi-tenant database system. A multi-tenant database system may store data for different tenants in a single database or a single set of databases. For example, the multi-tenant database system may store data for multiple tenants within a single table (e.g., in different rows) of a database. To support multi-tenant security, the multi-tenant database system may prohibit (e.g., restrict) a first tenant from accessing, viewing, or interacting in any way with data or rows associated with a different tenant. As such, tenant data for the first tenant may be isolated (e.g., logically isolated) from tenant data for a second tenant, and the tenant data for the first tenant may be invisible (or otherwise transparent) to the second tenant. The multi-tenant database system may additionally use encryption techniques to further protect tenant-specific data from unauthorized access (e.g., by another tenant).

Additionally, or alternatively, the multi-tenant system may support multi-tenancy for software applications and infrastructure. In some cases, the multi-tenant system may maintain a single instance of a software application and architecture supporting the software application in order to serve multiple different tenants (e.g., organizations, customers). For example, multiple tenants may share the same software application, the same underlying architecture, the same resources (e.g., compute resources, memory resources), the same database, the same servers or cloud-based resources, or any combination thereof. For example, the system 100 may run a single instance of software on a processing device (e.g., a server, server cluster, virtual machine) to serve multiple tenants. Such a multi-tenant system may provide for efficient integrations (e.g., using application programming interfaces (APIs)) by applying the integrations to the same software application and underlying architectures supporting multiple tenants. In some cases, processing resources, memory resources, or both may be shared by multiple tenants.

As described herein, the system 100 may support any configuration for providing multi-tenant functionality. For example, the system 100 may organize resources (e.g., processing resources, memory resources) to support tenant isolation (e.g., tenant-specific resources), tenant isolation within a shared resource (e.g., within a single instance of a resource), tenant-specific resources in a resource group, tenant-specific resource groups corresponding to a same subscription, tenant-specific subscriptions, or any combination thereof. The system 100 may support scaling of tenants within the multi-tenant system, for example, using scale triggers, automatic scaling procedures, scaling requests, or any combination thereof. In some cases, the system 100 may implement one or more scaling rules to enable relatively fair sharing of resources across tenants. For example, a tenant may have a threshold quantity of processing resources, memory resources, or both to use, which in some cases may be tied to a subscription by the tenant.

Additionally, or alternatively, the system 100 may support the use of a LLM (generative AI model), such as the generative AI component 145. In some examples, a generative AI component 145 may also be referred to as any of an AI, a generative AI (GAI), a GAI model, a LLM. The generative AI component 145 may be a model that is trained on a corpus of input data, which may include text, images, video, audio, structured data, or any combination thereof. Such data may represent general-purpose data, domain-specific data, or any combination thereof. Further, a generative AI component 145 may be supplemented with additional training on data associated with a role, function, or generation outcome to further specialize the generative AI component 145 and increase the accuracy and relevance of information generated with the generative AI component 145.

In some examples, the cloud platform 115 may receive a query from a cloud client 105 that may include a request to produce a response (e.g., text, images, video, audio, or other information) to the query using the generative AI component 145. The cloud platform 115 may transmit a prompt to the generative AI component 145 that includes the query (or information included therein) and receive the generated output (e.g., text, images, video, audio, or other information) that is responsive to the prompt. In some examples, the cloud platform 115 may modify or supplement one or more aspects of the query to increase the quality of the response. In some examples, such modification or supplementation may be referred to as grounding.

The system 100 may support any configuration for the use of generative AI models. In FIG. 1, the generative AI component 145 is depicted as being located outside of the subsystem 125. However, the generative AI component 145 may be hosted on the cloud platform 115, elsewhere within the subsystem 125, or outside the subsystem 125 (e.g., a publicly-hosted platform). Additionally, or alternatively, the generative AI component 145 may be employed by multiple components to perform one or more of the actions described as being performed by the generative AI component 145 (e.g., a single component). Further, in some examples, the generative AI component 145 may communicate with one or more other elements, such as a contact 110, the data center 120, one or more other elements, or any combination thereof, to receive additional information (e.g., that may be indicated in the query or the prompt) that is to be considered for performing generative processes.

In various implementations, the models and/or modules described herein may be classification, predictive, generative, conversational, or another form of AI (AI) technology, such as AI model(s), agents, etc., implementing one or more forms of machine learning, a neural network, statistical modeling, deep learning, automation, natural language processing, or other similar technology. The AI technology may be included as part of a network or system comprising a hardware-or software-based framework for training, processing, fine-tuning, or performing any other implementation steps. Furthermore, the AI technology may include a hardware-or software-based framework that performs one or more functions, such as retrieving, generating, accessing, transmitting, etc. The AI technology may be implemented by a computer including a register coupled with a processor or a central processing unit (CPU).

Moreover, the AI technology may be trained or fine-tuned using supervised, unsupervised, or other AI training techniques. In various implementations, the AI technology may be trained or fine-tuned using a set of general datasets or a set of datasets directed to a particular field or task. Additionally, or alternatively, the AI technology may be intermittently updated at a set interval or in real time based on resulting output or additional data to further train the AI technology. The AI technology may offer a variety of capabilities including text, audio, image, and other content generation, translation, summarization, classification, prediction, recommendation, time-series forecasting, searching, matching, pairing, and more. These capabilities may be provided in the form of output produced by the AI technology in response to a particular prompt or other input. Furthermore, the AI technology may implement Retrieval-Augmented Generation (RAG) or other techniques after training or fine-tuning by accessing a set of documents or knowledge base directed to a particular field or website other than the training or fine-tuning data to influence the AI technology's output with the set of documents or knowledge base.

To further guide and train output of the AI technology, a plurality of input prompts may be provided to the AI technology for the purpose of eliciting particular responses. In various implementations, the plurality of input prompts may correspond to the particular field or task to which the AI technology is trained. Additionally, the AI technology may be implemented along with a plurality of additional AI technologies. For example, a first AI model may produce a first output, which is used as input for a second AI model to produce a second output. These AI technologies may be used in succession of one another, in parallel with another, or a combination of both. Furthermore, the AI technologies may be merged in a variety of implementations, for example, by bagging, boosting, stacking, etc. the AI technologies.

In some examples, tenants within a multi-tenant system (e.g., the system 100) may use applications that utilize LLMs. In some cases, the applications may utilize the LLMs by executing one or more LLM prompts that includes sets of instructions for the LLM. Further, in some examples, applications may use LLM prompts that are generic and are untrained for respective tenants, applications, or both. For example, an LLM prompt may be initially designed or generated to perform a respective task or to operate within an application before interacting with any real user data. Thus, to ensure that the LLMs of an application generate relatively high quality and reliable responses, system administrators may have to perform one or more adjustments or updates on the LLM prompts to improve the performance of an LLM based on performance metrics. For example, a system administrator may use user data to generate different versions of an LLM prompt and perform tests and experiments to generate an LLM prompt that is specific to the tenant of the system administrator and the application. However, as tenants may implement a relatively high quantity of applications utilizing LLMs (e.g., LLM applications), having administrators continuously experiment with different prompt versions for different applications may be impractical and inefficient. Therefore, current techniques of manually adjusting LLM prompts based on user data and user feedback may be inefficient as the quantity of applications that utilize LLMs that tenants use increases. Moreover, a lack of techniques to automatically evaluate and improve prompts of LLMs in real-time may further decrease the overall effectiveness of LLM applications.

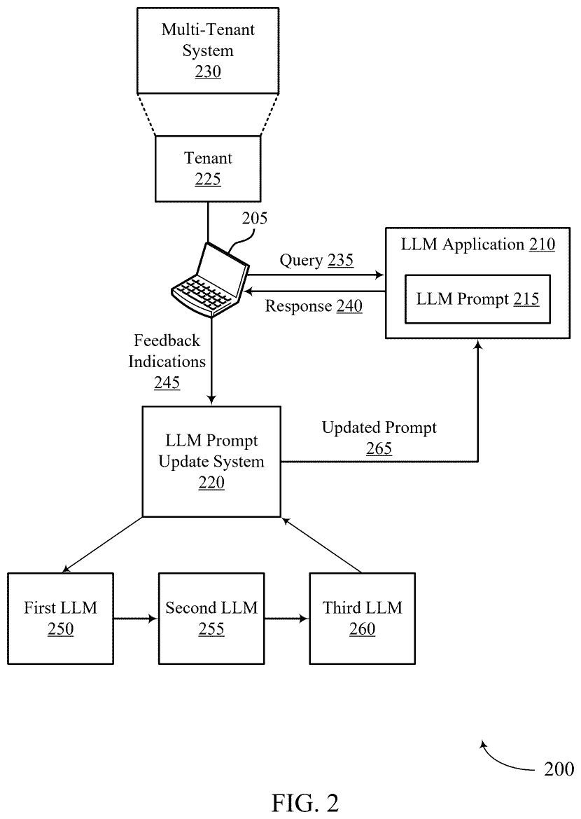

The present disclosure describes techniques for automatically fine-tuning LLM prompts based on user-feedback. For example, the system 100 may receive a set of feedback indications from a set of users in response to the set of users receiving a response from an application that uses an application-specific LLM prompt for accessing a target LLM. In some cases, the feedback indications may indicate a level of quality, accuracy, reliability, and the like, or the feedback indications may simply indicate whether a response was good or bad. In response to receiving the set of feedback indications, the system 100 may transmit each feedback indication and each corresponding response to a first LLM to obtain a set of feedback evaluations based on the first LLM being configured and trained to evaluate feedback. The system 100 may then concatenate or put all the feedback evaluations together into a single input for a second LLM that is configured and trained to generate summaries of information. Based on the transmission of the set of feedback evaluations to the second LLM, the system may then obtain a summary of the set of feedback evaluations that summarizes the issues with the responses from the target LLM that resulted in the set of users providing the set of feedback indications. Using the summary of the set of feedback evaluations, the system 100 may transmit the summary and the application-specific LLM prompt used to a third LLM that is configured and trained to fine-tune LLM prompts. As a result, the system 100 may receive a set of updated parameters for the application-specific LLM prompt that the system 100 may use to configure the application. For example, the system 100 may configure the application to use the application-specific LLM with the set of updated parameters for accessing the target LLM. Therefore, the techniques of the present disclosure may enable the system 100 to autonomously update and adjust parameters of an application-specific LLM prompt to improve the results of responses from the target LLM. Further descriptions of the techniques of the present disclosure may be described elsewhere herein, such as with reference to FIGS. 2 through 4.

It should be appreciated by a person skilled in the art that one or more aspects of the disclosure may be implemented in a system 100 to additionally, or alternatively, solve other problems than those described above. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

FIG. 2 shows an example of a computing system 200 that supports user-feedback based prompt tuning for AI applications in accordance with aspects of the present disclosure. In some examples, the computing system 200 implements or may be implemented by the system 100. For example, the computing system 200 may illustrate a computing device 205 that may communicate with an LLM application 210 that uses an LLM prompt 215 and may communicate with an LLM prompt update system 220, that may be implemented by devices or services described with reference to FIG. 1.

In some examples, a user operating the computing device 205 may be associated with a tenant 225 of a multi-tenant system 230. For example, a user may be a member of a group of users, a team, an organization, or any combination thereof associated with a tenant 225 of the multi-tenant system 230. In some cases, users associated with a respective tenant may use one or more applications and the applications may be used by multiple different tenants. For example, a respective application may be a multi-tenant application that is associated with the multi-tenant system 230.

In some examples, users of a tenant 225 may use multi-tenant generative AI applications that use LLMs, such as the LLM application 210. Further, the LLM application 210 may have a LLM prompt 215 (e.g., a task prompt) that instructs the LLM application 210 to perform one or more actions or tasks. For example, the LLM prompt 215 may include instructions for an LLM associated with the LLM application 210 to generate summaries of information or to generate text based on an input to the LLM from the users of the LLM application 210 (e.g., the users operating the computing device 205 that are associated with the tenant 225). In some cases, the LLM prompt 215 may be initially designed or generated based on a limited benchmark. For example, the LLM prompt 215 may include generic instructions to perform a respective task. Therefore, the LLM prompt 215 of the LLM application 210 may have limited or no prior knowledge of performance for a tenant 225 of the multi-tenant system 230 that use the LLM application 210. Thus, since the LLM prompt 215 may be designed before interacting with real user data, a tenant 225 may have to continuously adjust the LLM prompt 215 based on performance of the LLM prompt 215 within the LLM application 210. In some examples, a summarization type prompt may be generic across multiple different tenants, and such a generic prompt may be adapted to the particular use cases and/or data for the different tenants. Thus, the generic prompt may result in inaccurate and/or incomplete prompt responses. Similar generic prompts may be used for different use cases across multiple tenants.

To adjust the LLM prompt 215, a system administrator (e.g., an administrative user of a tenant 225) may perform a prompt engineering procedure based on user feedback. For example, the system administrator or a feedback system may monitor the performance of the LLM prompt 215 within the LLM application 210 by collecting feedback on the responses generated by the LLM of the LLM application 210 (e.g., a target LLM accessed by the LLM application 210 using the LLM prompt 215). To collect such feedback, a user of the computing device 205 may transmit a query 235 to the LLM application 210 and the user may receive a response 240 from the LLM application 210 that is based on the query 235. After receiving the response 240, the user may then provide a feedback indication for the response. For example, the user may select a ‘thumbs up’ icon within a user interface of the LLM application 210 to indicate that the response 240 is good thus providing a positive feedback indication or the user may select a ‘thumbs down’ icon to indicate that the response 240 is bad thus providing a negative feedback indication. In another example, the user may provide a more detailed feedback indication that includes a comment within a natural language format that may highlight the quality, accuracy, reliability, or any combination thereof of the response 240.

In some examples, using this information the system administrator may have to manually adjust the LLM prompt 215 to improve the feedback from the responses. For example, when adjusting the LLM prompt 215, the system administrator may test multiple versions of the LLM prompt 215 with different sets of users to determine whether aspects of a first prompt result in relatively more positive feedback than aspects of a second prompt. In some cases, such testing may be referred to as A/B testing where a first version of a prompt (e.g., prompt A) and a second version of a prompt (e.g., prompt B) are tested simultaneously with different sets of users of a tenant 225. Further, it should be understood that such testing may include any quantity of prompt versions of the LLM prompt 215.

Moreover, as the quantity of applications (e.g., an LLM application 210) that utilize LLMs that system administrators of a tenant 225 increases, having the system administrators collect the feedback from the users and manually adjust the LLM prompt 215 of an LLM application 210 may be inefficient and unreliable. Thus, in accordance with the techniques of the present disclosure, a tenant 225 of the multi-tenant system 230 may utilize an LLM prompt update system 220 that can collect a set of feedback indications 245 from the users of a computing device 205 associated with the respective tenant to automatically adjust the LLM prompt 215 of the LLM application 210. For example, to reduce the time-consumption of manually adjusting the LLM prompt 215 of a LLM prompt 215, the LLM prompt update system 220 may utilize a three-step approach to automatically update the LLM prompt 215 based on real-time user feedback to ensure that relatively high performance of the LLM application 210.

Further, the LLM prompt update system 220 may utilize a set of LLMs that are trained for specific tasks to ensure that the updates to the LLM prompt 215 are accurate and reliable. For example, the LLM prompt update system 220 may transmit the feedback indications to a first LLM 250 to evaluate the feedback indications and generate a set of feedback evaluations. The first LLM 250 may then transmit the set of feedback evaluations to a second LLM 255 to generate a summary of the feedback evaluations. Further, the second LLM 255 may then transmit the summary of the feedback evaluations to a third LLM 260 to generate a set of updated parameters for the LLM prompt 215. Therefore, the LLM prompt update system 220 may be capable of suggesting edits or updates to the LLM prompt 215 based on the performance of the LLM application 210 using the LLM prompt 215. For example, in some cases the LLM prompt update system 220 may configure the LLM application 210 with an updated LLM prompt 265 that includes the set of updated parameters generated via the third LLM 260.

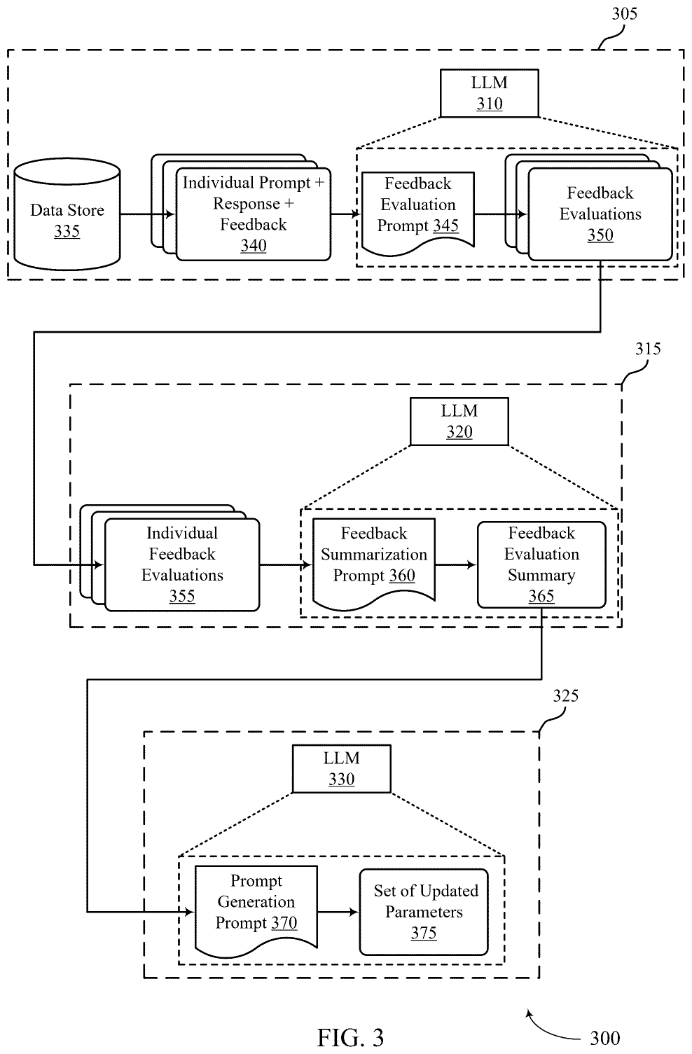

In some examples, the LLM prompt update system 220 may periodically run the three-step procedure to generate the updated LLM prompt 265. For example, the LLM prompt update system 220 may generate the updated LLM prompt 265 based on a performance metric threshold being satisfied, after a threshold quantity or duration of time, or a combination thereof to ensure that the LLM prompt 215 of the LLM application 210 remains up-to-date based on the user feedback from the set of feedback indications 245. In some other examples, if a system administrator is skilled at prompt engineering and modifying the LLM prompt 215, the LLM prompt update system 220 may provide the system administrator with the summary of feedback evaluations that is generated via the second LLM 255. For example, the system administrator may review the summary of feedback evaluations that indicates the issues with the LLM prompt 215 and perform a prompt engineering procedure to adjust the LLM prompt 215 based on the summary of feedback evaluations. Therefore, by utilizing the LLM prompt update system 220 within the computing system 200, system administrators may be capable of automating the procedure of updating the LLM prompt 215 of the LLM application 210 based on the user feedback. Thus, the LLM prompt update system 220 may increase the reliability of the LLM application 210 by ensuring that the LLM prompt 215 is updated based on the user feedback and the LLM prompt update system 220 may decrease the latency associated with such updates by performing the three-step procedure described herein. Further descriptions of the techniques of the present disclosure describing the LLM prompt update system 220 performing a three-step procedure to generate the updated LLM prompt 265 may be described elsewhere herein, such as with reference to FIG. 3. Thus, using these techniques described herein, tenant, data, and application specific prompts may be generated, and prompts that have similar use cases across tenants (e.g., summarization prompt) may be different across tenants due to the results of the prompt update techniques described herein.

FIG. 3 shows an example of a system diagram 300 that supports user-feedback based prompt tuning for AI applications in accordance with aspects of the present disclosure. In some examples, the system diagram 300 implements or may be implemented by the system 100, the computing system 200, or both. For example, the system diagram 300 may illustrate and describe the procedure performed by the LLM prompt update system 220 in accordance with the techniques of the present disclosure to generate the updated LLM prompt 265, as described with reference to FIG. 2. Further, the procedure and steps illustrated and described in the system diagram 300 may be implemented by devices or services described with reference to FIG. 1, such as a cloud client 105, a contact 110, the cloud platform 115, the generative AI component 145, or any combination thereof. For example, the system diagram 300 may illustrate an LLM prompt tuning service performing an evaluation procedure 305 that utilizes an LLM 310, a summarization procedure 315 that utilizes an LLM 320, and a LLM prompt update procedure 325 that utilizes an LLM 330 to automatically update an LLM prompt based on user feedback.

In some examples, as part of the evaluation procedure 305, an LLM prompt tuning service may evaluate a set of feedback indications associated with a set of responses from a target LLM of a first application. For example, the LLM prompt tuning service may receive the set of feedback indications associated with the set of responses and store both the set of feedback indication and the set of responses within a data store 335. In some examples, the LLM prompt tuning service may store each feedback indication and associated response as a triple within the data store 335. For example, the LLM prompt tuning service may store a feedback indication, the response associated with the feedback indication, and the LLM prompt that was used to generate the response, within a single data item (e.g., data object, JavaScript object notation (JSON) object, row of a database) within the data store 335. In some examples, the data store 335 may be an example of a data base, a cloud platform 115, a data center 120, or any combination thereof.

Further, as part of the evaluation procedure 305, the LLM prompt tuning service may sample N triples 340 that include a respective LLM prompt, response, and feedback indication. For example, the LLM prompt tuning service may collect a set of positive and negative feedback indications to be evaluated. In another example, the LLM prompt tuning service may filter out positive feedback indications and may solely store feedback indications and the associated responses and prompts that indicate negative feedback. Then, for each individual triple 340 (e.g., each feedback indication, response associated with the feedback indication, and LLM prompt that generated the response), the LLM prompt tuning service may input the LLM prompt, response, and feedback indication into a feedback evaluation prompt 345 associated with the LLM 310 (e.g., a first LLM). For example, for each triple 340 (e.g., for each feedback indication and response associated with the feedback indication), the LLM prompt tuning service may complete the feedback evaluation prompt 345 of the LLM 310 with the respective triple 340 that includes a respective feedback indication, a respective response associated with the respective feedback indication, and an application-specific LLM prompt used to generate the respective response. Moreover, in some cases, the LLM prompt tuning service may complete the feedback evaluation prompt 345 with respective triples 340 based on a threshold being satisfied. For example, the LLM prompt tuning service may complete the feedback evaluation prompt 345 based on satisfaction of a feedback indication quantity threshold associated with a threshold quantity of feedback indications, a time threshold associated with a threshold quantity of time since a previous update to the set of parameters of the application-specific LLM prompt, or both.

Further, in some examples, the LLM 310 may be configured and trained to evaluate feedback from a set of users based on the feedback evaluation prompt 345 and the LLM prompt tuning service completing the feedback evaluation prompt 345. For example, the LLM prompt tuning service may perform a first training procedure on the LLM 310 to train the LLM to evaluate feedback that is associated with respective responses from a respective LLM based on a respective LLM prompt. Thus, the LLM 310 may be specially trained and configured for the task of evaluating the feedback from users that is associated with responses from an LLM application. Therefore, the LLM 310 may execute the instructions included within the feedback evaluation prompt 345 to generate a set of feedback evaluations 350. For example, the instructions included within the feedback evaluation prompt 345 may prompt the LLM 310 to provide feedback on items that are present or lacking in a respective response that led to a positive feedback indication or negative feedback indication. Additionally, or alternatively, the steps of the evaluation procedure 305 of completing the feedback evaluation prompt 345 with a respective triple 340 and the LLM 310 executing the feedback evaluation prompt 345 to generate a feedback evaluation may be performed iteratively for each triple 340 within the data store 335 that is associated with the same application-specific LLM prompt.

Based on the evaluation procedure 305 utilizing the LLM 310 to generate the set of feedback evaluations 350, the LLM prompt tuning service may initiate the summarization procedure 315 to summarize the set of feedback evaluations 350. For example, as part of the summarization procedure 315, the LLM prompt tuning service may collect and store each individual feedback evaluation 355 of the set of feedback evaluations 350 for summarization. In some cases, when collecting the individual feedback evaluations 355, the LLM prompt tuning service may concatenate each individual feedback evaluation 355 of the set of feedback evaluations 350 into a concatenated feedback evaluation input. Once concatenated, the LLM prompt tuning service may complete (e.g., hydrate) a feedback summarization prompt 360 of the LLM 320 with the concatenated feedback evaluation input. Thus, the LLM 320 may execute the instructions of the feedback summarization prompt 360 and generate a feedback evaluation summary 365 of the set of feedback evaluations 350 (e.g., a summary of the set of feedback evaluations 350). Moreover, in some cases, the LLM 320 may be configured to generate the summary. For example, the LLM prompt tuning service may perform a second training procedure on the LLM 320 (e.g., a second LLM) to train the LLM prompt update system 220 to generate summaries. Thus, the LLM 320 may be configured to generate the feedback evaluation summary 365 based on the second training procedure, the feedback summarization prompt 360, and on the LLM prompt tuning service completing the feedback summarization prompt 360 with the concatenated feedback evaluation input.

In some examples, when providing the feedback summarization prompt 360 of the LLM 320 with the concatenated feedback evaluation input generated from the set of feedback evaluations 350, the context window of the LLM 320 may be exceeded. For example, an LLM may be limited by a quantity of text (e.g., in terms of tokens or characters) that the LLM can use as an input for generating a response or for performing a text. Thus, in some cases, the text of the feedback summarization prompt 360 with the concatenated feedback evaluation input may exceed the context window (e.g., the maximum quantity of tokens allowed) of the LLM 320. Therefore, in some examples, the LLM prompt tuning service may segment the concatenated feedback evaluation input into multiple segments or portions that fit within the context window of the LLM 320, perform the summarization procedure 315 on each segment of the concatenated feedback evaluation input to generate a feedback evaluation summary 365, concatenated each feedback evaluation summary 365, and then perform the summarization procedure 315 on the concatenated feedback evaluation summary 365. In some cases, such procedure may be referred to as a summary of summaries procedure where an LLM generates summaries on segments of a relatively large input, concatenates all the summaries, and then the LLM generates a summary of the summaries. Further, in some examples, the concatenation of the summaries may still be too large for the context window of the LLM 320, thus, the LLM prompt tuning service may perform the summary of summaries procedure again until a single feedback evaluation summary 365 of the set of feedback evaluations 350 can be generated.

Once the LLM prompt tuning service obtains the feedback evaluation summary 365 from the LLM 320, as part of the LLM prompt update procedure 325, the LLM prompt tuning service may complete (e.g., hydrate) a prompt generation prompt 370. For example, the LLM prompt tuning service may input the feedback evaluation summary 365, the application-specific prompt, and one or more of the triples 340 stored within the data store 335 into the prompt generation prompt 370. In some cases, providing the feedback evaluation summary 365 with a few examples of responses with positive feedback indications and responses with negative feedback indication may provide the feedback evaluation summary 365 with some context of for generation of a set of updated parameters 375.

Therefore, the LLM 330 may then execute the instructions within the prompt generation prompt 370 to generate a set of updated parameters 375 for the application-specific LLM prompt. Using the set of updated parameters, the LLM prompt tuning service may then configure the first application (e.g., the LLM application) to use the application-specific LLM prompt with the set of updated parameters 375 for accessing the target LLM. In some examples, to generate the set of updated parameters 375 the LLM 330 may be configured or trained to fine-tune LLM prompts. For example, the LLM prompt tuning service may perform a third training procedure on the LLM 330 (e.g., a third LLM) to train the LLM 330 to fine-tune LLM prompts associated with applications. In some cases, the LLM 330 may generate the set of updated parameters 375 based on the LLM 330 generating one or more insights from the feedback evaluation summary 365. For example, the feedback evaluation summary 365 may indicate portions or segments within an application-specific LLM prompt that result in positive feedback indications, portions or segments within an application-specific LLM prompt that results in negative feedback indications, or both. In some examples, the set of updated parameters 375 for the application-specific LLM prompt may update the application-specific LLM prompt to include examples of responses that are associated with negative feedback indications. Moreover, the examples may also include explanations of why the responses received negative feedback indications.

Therefore, by having the system diagram 300 of an LLM prompt tuning service perform an evaluation procedure 305, a summarization procedure 315, and a LLM prompt update procedure 325, tenants may be capable of utilizing the techniques of the present disclosure to improve the performance of prompts. For example, in some cases, the LLM prompt tuning service may initiate an application-specific LLM prompt tuning procedure after receiving the set of feedback indications associated with the set of responses to update the set of parameters of the application-specific LLM prompt. Moreover, the application-specific LLM prompt tuning procedure may include transmission of the set of feedback indications from the data store 335 to the LLM 310, transmission of the set of feedback evaluations 350 to the LLM 320, and transmission of the feedback evaluation summary 365 to the LLM 330. In some cases, after the application-specific LLM prompt is updated, the LLM prompt tuning service may receive a second set of feedback indications associated with a second set of responses and a performance metric associated with the second set of feedback indications may be less than a performance threshold. For example, a quantity of positive feedback indications within the second set of feedback indications may be less than a threshold quantity of positive feedback indications. Thus, the LLM prompt tuning service may initiate the application-specific LLM prompt tuning procedure again until a respective set of feedback indications satisfies the performance threshold.

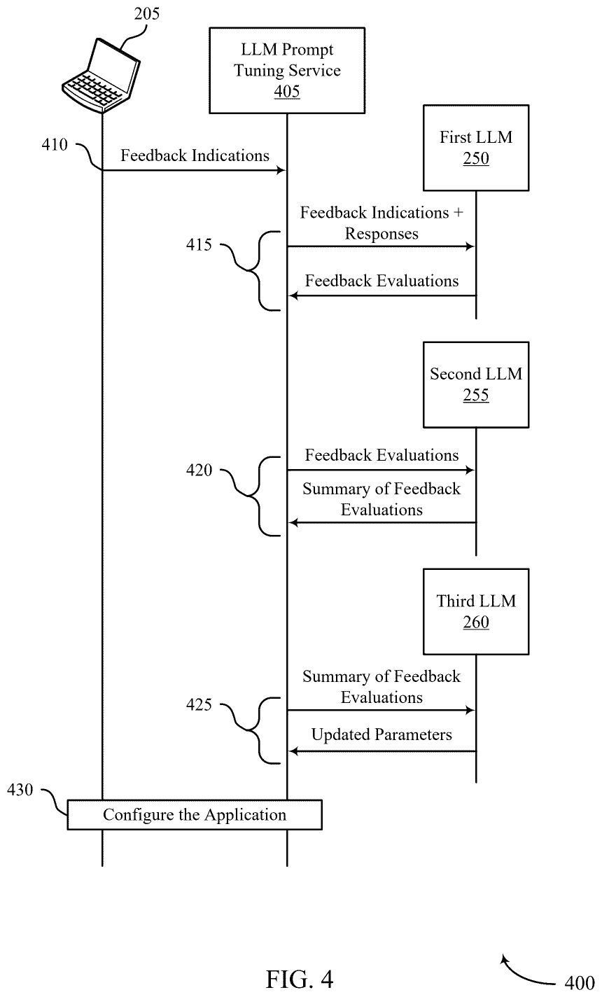

Therefore, in accordance with the techniques of the present disclosure, the LLM prompt tuning service may be capable of synthesizing user feedback to improve the performance of an application-specific LLM prompt. For example, in some cases, the LLM prompt tuning service may provide a summary of actionable steps for an administrative user to perform to update an application-specific LLM prompt. In some other cases, the LLM prompt tuning service may generate a summary of advice to improve an application-specific LLM prompt (e.g., a task specific prompt) and may generate an updated application-specific LLM prompt or the set of updated parameters 375 for the application-specific LLM prompt. Further descriptions of the techniques of the present disclosure describing the LLM prompt tuning service improving an application-specific LLM prompt based on user feedback may be described elsewhere herein, such as with reference to FIG. 4.

FIG. 4 shows an example of a process flow 400 that supports user-feedback based prompt tuning for AI applications in accordance with aspects of the present disclosure. In some examples, the process flow 400 may implement or may be implemented by the system 100, the computing system 200, the system diagram 300, or any combination thereof. The process flow 400 may include the computing device 205, an LLM prompt tuning service 405, a first LLM 250, a second LLM 255, and a third LLM 260, which may be examples of devices or services described elsewhere herein including with reference to FIGS. 1 through 3. Further, one or more users may operate the computing device 205 as described elsewhere herein with reference to FIGS. 1 and 2.

In the following description of the process flow 400, the operations may be performed by the computing device 205, the LLM prompt tuning service 405, the first LLM 250, the second LLM 255, and the third LLM 260 in different orders or at different times.

Some operations may also be left out of the process flow 400, or other operations may be added. Although the process flow 400 may be described as being performed by the computing device 205, the LLM prompt tuning service 405, the first LLM 250, the second LLM 255, and the third LLM 260, some aspects of some operations may also be performed by other devices, services, or models described elsewhere herein including with reference to FIGS. 1 through 3.

At 410, the LLM prompt tuning service 405 may receive, from a set of users (e.g., users operating the computing device 205) of a first application that uses an application-specific LLM prompt for accessing a target LLM, a set of feedback indications associated with a set of responses from the target LLM based on the application-specific LLM prompt that includes a set of parameters. In some examples, the set of users may be associated with a first tenant of a set of tenants that utilize the first application. In some other examples, the set of users may utilize a set of applications that use respective application-specific LLM prompts for accessing respective target LLMs, the set of applications including the first application that uses the application-specific LLM prompt for accessing the target LLM. In some cases, the LLM prompt tuning service 405 may receive, from the set of users of the first application, a set of positive feedback indications associated with a first subset of responses of the set of responses and a set of negative feedback indications associated with a second subset of responses of the set of responses, the set of feedback indications including the set of positive feedback indications and the set of negative feedback indications. Additionally, or alternatively, after receiving the plurality of feedback indications associated with the plurality of responses, the LLM prompt tuning service 405 may initiate an application-specific LLM prompt tuning procedure to update the set of parameters of the application-specific LLM prompt. Moreover, the application-specific LLM prompt tuning procedure may include the LLM prompt tuning service 405 transmitting a set of feedback indications to the first LLM 250, transmitting a set of feedback evaluations to the second LLM 255, and transmitting a summary of the set of feedback evaluations to the third LLM 260.

At 415, the LLM prompt tuning service 405 may transmit, to a first LLM 250 configured to evaluate feedback, the set of feedback indications and the set of responses associated with the set of feedback indications. The transmission of the set of feedback indications may result in the LLM prompt tuning service 405 obtaining a set of feedback evaluations generated by the first LLM 250. In some examples, the transmission of the set of feedback indications to the first LLM 250 may include transmitting the set of negative feedback indications to the first LLM 250 and refraining from transmitting the set of positive feedback indications to the second LLM 255. In some other examples, the transmission of the set of feedback indications to the first LLM 250 may include identifying, in response to receiving the set of feedback indications from the set of users, that a threshold is satisfied and transmitting, to the first LLM 250, the set of feedback indications based on satisfaction of the threshold. In some examples, the threshold may include a feedback indication quantity threshold associated with a threshold quantity of feedback indications, a time threshold associated with a threshold quantity of time since an update to the set of parameters of the application-specific LLM prompt, or both. Further, in some cases, the transmission of the set of feedback indications and the set of responses to the first LLM 250 may include completing, for each feedback indication and response associated with the feedback indication, a prompt of the first LLM 250 with a data triple including a respective feedback indication, a respective response associated with the respective feedback indication, and the application-specific LLM prompt, where the first LLM 250 is configured to evaluate the feedback based on the prompt of the first LLM 250 and on completion of the prompt of the first LLM 250. Further, the LLM prompt tuning service 405 may perform a first training procedure on the first LLM 250 to train the first LLM 250 to evaluate feedback that is associated with respective responses from a respective LLM based on a respective LLM prompt. Thus, the first LLM 250 may be configured to evaluate feedback based on the first training procedure.

At 420, the first LLM 250 may transmit a set of feedback evaluations to the second LLM 255, which is configured to generate summaries. The transmission of the set of feedback evaluations may result in a summary of the set of feedback evaluations generated by the second LLM 255. In some examples, transmitting the set of feedback evaluations to the second LLM 255 may include concatenating the set of feedback evaluations into a concatenated feedback evaluation input and completing a prompt of the second LLM 255 with the concatenated feedback evaluation input. The second LLM 255 may be configured to generate the summaries based on the prompt of the second LLM 255 and on completion of the prompt of the second LLM 255. Additionally, or alternatively, the LLM prompt tuning service 405 may perform a second training procedure on the second LLM 255 to train the second LLM 255 to generate summaries. Thus, the second LLM 255 may be configured to generate summaries based on the second training procedure.

At 425, the second LLM 255 may transmit the summary of the set of feedback evaluations to the third LLM 260, which is configured to fine-tune LLM prompts associated with applications. The transmission of the summary of the set of feedback evaluations may result in the LLM prompt tuning service 405 obtaining a set of updated parameters for the application-specific LLM prompt. In some examples, transmitting the summary of the set of feedback evaluations to the third LLM 260 may include the LLM prompt tuning service 405 completing a prompt of the third LLM 260 with the summary of the set of feedback evaluations, the application-specific LLM prompt, and one or more data triples. Each data triple may include a respective feedback indication of the set of feedback indications, a respective response associated with the respective feedback indication of the set of responses, and a respective feedback evaluation of the set of feedback evaluations associated with the respective feedback indication and the respective response. Moreover, the third LLM 260 may be configured to fine-tune the LLM prompts based on the prompt of the third LLM 260 and on completion of the prompt of the third LLM 260. Additionally, or alternatively, the LLM prompt tuning service 405 may perform a third training procedure on the third LLM 260 to train the third LLM 260 to fine-tune LLM prompts associated with applications. Thus, the third LLM 260 may be configured to fine-tune LLM prompts based on the third training procedure.

At 430, the LLM prompt tuning service 405 may configure the first application to use the application-specific LLM prompt with the set of updated parameters for accessing the target LLM. In some examples, the LLM prompt tuning service 405 may receive a set of updated responses from the target LLM associated with the first application. The set of updated responses may be based on the application-specific LLM prompt of the first application utilizing the set of updated parameters in accordance with a configuration of the first application. Thus, the LLM prompt tuning service 405 may transmit the set of updated responses to the set of users of the first application in response to reception of the set of updated responses. In some other examples, the LLM prompt tuning service 405 may receive a second set of feedback indications from the set of users of the first application. The second set of feedback indications may be associated with a second set of responses from the target LLM based on the application-specific LLM prompt utilizing the set of updated parameters based on configuring the first application. Moreover, the LLM prompt tuning service 405 may determine that a performance metric associated with the second set of feedback indications is less than a performance threshold. For example, the performance threshold may be associated with a threshold quantity of positive feedback indications. In response to the LLM prompt tuning service 405 receiving the second set of feedback indications and the second set of feedback indications being less than the performance threshold, LLM prompt tuning service 405 may then initiate the application-specific LLM prompt tuning procedure. Additionally, or alternatively, the LLM prompt tuning service 405 may continue the application-specific LLM prompt tuning procedure until a respective set of feedback indications satisfies the performance threshold.

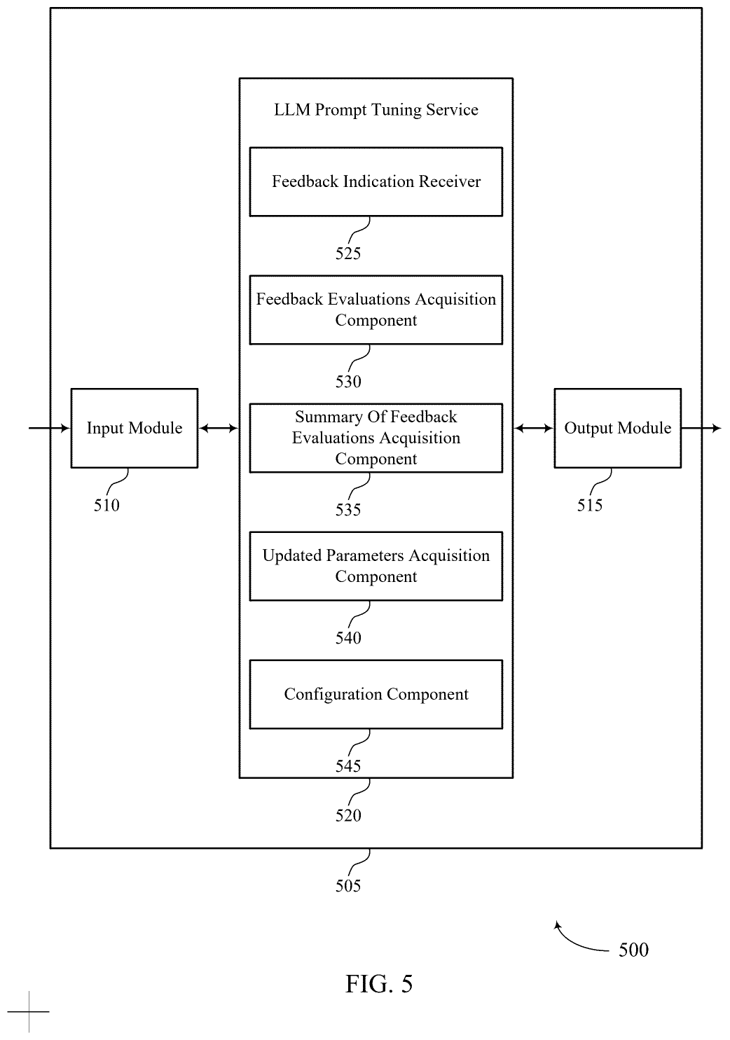

FIG. 5 shows a block diagram 500 of a device 505 that supports user-feedback based prompt tuning for AI applications in accordance with aspects of the present disclosure. The device 505 may include an input module 510, an output module 515, and an LLM prompt tuning service 520. The device 505, or one or more components of the device 505 (e.g., the input module 510, the output module 515, the LLM prompt tuning service 520), may include at least one processor, which may be coupled with at least one memory, to support the described techniques. Each of these components may be in communication with one another (e.g., via one or more buses).

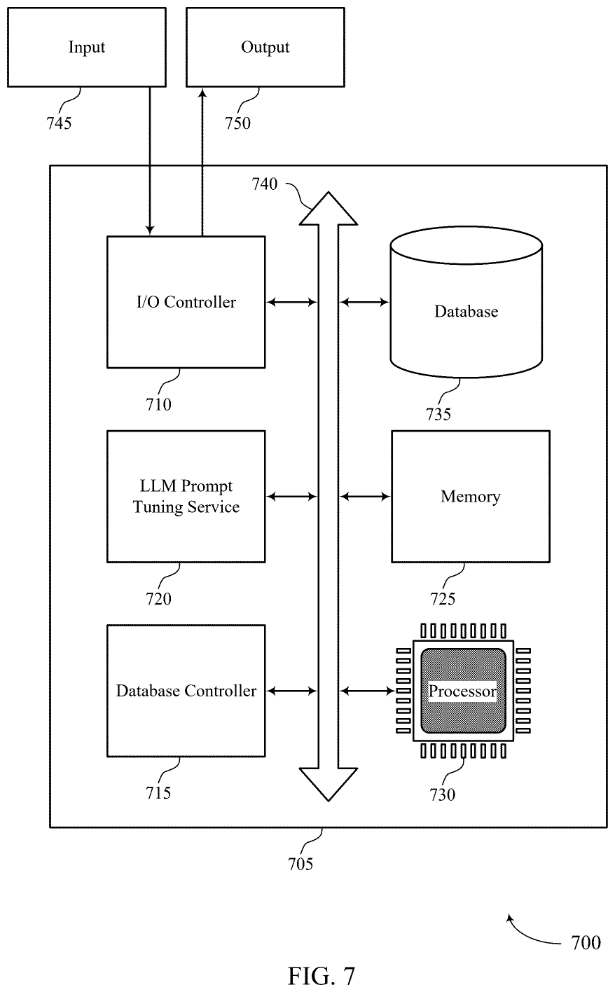

The input module 510 may manage input signals for the device 505. For example, the input module 510 may identify input signals based on an interaction with a modem, a keyboard, a mouse, a touchscreen, or a similar device. These input signals may be associated with user input or processing at other components or devices. In some cases, the input module 510 may utilize an operating system such as iOS®, ANDROID®, MS-DOS®, MS-WINDOWS®, OS/2®, UNIX®, LINUX®, or another known operating system to handle input signals. The input module 510 may send aspects of these input signals to other components of the device 505 for processing. For example, the input module 510 may transmit input signals to the LLM prompt tuning service 520 to support user-feedback based prompt tuning for AI applications. In some cases, the input module 510 may be a component of an input/output (I/O) controller 710 as described with reference to FIG. 7.

The output module 515 may manage output signals for the device 505. For example, the output module 515 may receive signals from other components of the device 505, such as the LLM prompt tuning service 520, and may transmit these signals to other components or devices. In some examples, the output module 515 may transmit output signals for display in a user interface, for storage in a database or data store, for further processing at a server or server cluster, or for any other processes at any number of devices or systems. In some cases, the output module 515 may be a component of an I/O controller 710 as described with reference to FIG. 7.

For example, the LLM prompt tuning service 520 may include a feedback indication receiver 525, a feedback evaluations acquisition component 530, a summary of feedback evaluations acquisition component 535, an updated parameters acquisition component 540, a configuration component 545, or any combination thereof. In some examples, the LLM prompt tuning service 520, or various components thereof, may be configured to perform various operations (e.g., receiving, monitoring, transmitting) using or otherwise in cooperation with the input module 510, the output module 515, or both. For example, the LLM prompt tuning service 520 may receive information from the input module 510, send information to the output module 515, or be integrated in combination with the input module 510, the output module 515, or both to receive information, transmit information, or perform various other operations as described herein.

The LLM prompt tuning service 520 may support fine-tuning a LLM prompt in accordance with examples as disclosed herein. The feedback indication receiver 525 may be configured to support receiving, from a set of multiple users of a first application that uses an application-specific LLM prompt for accessing a target LLM, a set of multiple feedback indications associated with a set of multiple responses from the target LLM based on the application-specific LLM prompt, where the application-specific LLM prompt includes a set of parameters. The feedback evaluations acquisition component 530 may be configured to support transmitting, to a first LLM configured to evaluate feedback, the set of multiple feedback indications and the set of multiple responses associated with the set of multiple feedback indications, where transmission of the set of multiple feedback indications results in a set of multiple feedback evaluations generated by the first LLM. The summary of feedback evaluations acquisition component 535 may be configured to support transmitting, to a second LLM configured to generate summaries, the set of multiple feedback evaluations obtained from the first LLM, where transmission of the set of multiple feedback evaluations results in a summary of the set of multiple feedback evaluations generated by the second LLM. The updated parameters acquisition component 540 may be configured to support transmitting, to a third LLM configured to fine-tune LLM prompts, the summary of the set of multiple feedback evaluations obtained from the second LLM and the application-specific LLM prompt associated with the set of multiple responses, where transmission of the summary of the set of multiple feedback evaluations results in a set of updated parameters for the application-specific LLM prompt. The configuration component 545 may be configured to support configuring the first application to use the application-specific LLM prompt with the set of updated parameters for accessing the target LLM.

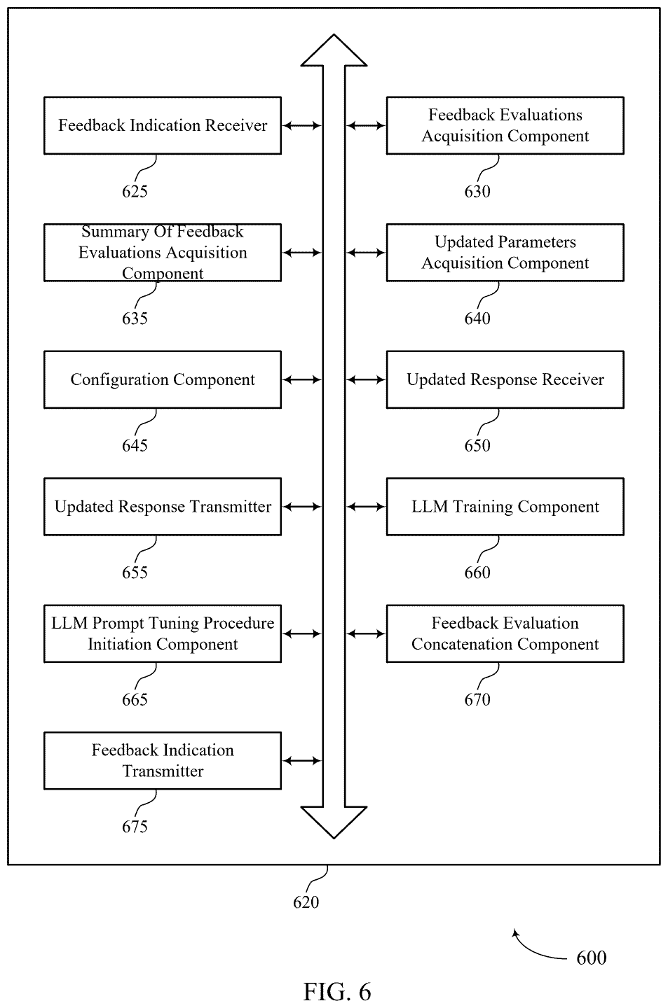

FIG. 6 shows a block diagram 600 of an LLM prompt tuning service 620 that supports user-feedback based prompt tuning for AI applications in accordance with aspects of the present disclosure. The LLM prompt tuning service 620 may be an example of aspects of an LLM prompt tuning service or an LLM prompt tuning service 520, or both, as described herein. The LLM prompt tuning service 620, or various components thereof, may be an example of means for performing various aspects of user-feedback based prompt tuning for AI applications as described herein. For example, the LLM prompt tuning service 620 may include a feedback indication receiver 625, a feedback evaluations acquisition component 630, a summary of feedback evaluations acquisition component 635, an updated parameters acquisition component 640, a configuration component 645, an updated response receiver 650, an updated response transmitter 655, an LLM training component 660, an LLM prompt tuning procedure initiation component 665, a feedback evaluation concatenation component 670, a feedback indication transmitter 675, or any combination thereof. Each of these components, or components of subcomponents thereof (e.g., one or more processors, one or more memories), may communicate, directly or indirectly, with one another (e.g., via one or more buses).

The LLM prompt tuning service 620 may support fine-tuning a LLM prompt in accordance with examples as disclosed herein. The feedback indication receiver 625 may be configured to support receiving, from a set of multiple users of a first application that uses an application-specific LLM prompt for accessing a target LLM, a set of multiple feedback indications associated with a set of multiple responses from the target LLM based on the application-specific LLM prompt, where the application-specific LLM prompt includes a set of parameters. The feedback evaluations acquisition component 630 may be configured to support transmitting, to a first LLM configured to evaluate feedback, the set of multiple feedback indications and the set of multiple responses associated with the set of multiple feedback indications, where transmission of the set of multiple feedback indications results in a set of multiple feedback evaluations generated by the first LLM. The summary of feedback evaluations acquisition component 635 may be configured to support transmitting, to a second LLM configured to generate summaries, the set of multiple feedback evaluations obtained from the first LLM, where transmission of the set of multiple feedback evaluations results in a summary of the set of multiple feedback evaluations generated by the second LLM. The updated parameters acquisition component 640 may be configured to support transmitting, to a third LLM configured to fine-tune LLM prompts, the summary of the set of multiple feedback evaluations obtained from the second LLM and the application-specific LLM prompt associated with the set of multiple responses, where transmission of the summary of the set of multiple feedback evaluations results in a set of updated parameters for the application-specific LLM prompt. The configuration component 645 may be configured to support configuring the first application to use the application-specific LLM prompt with the set of updated parameters for accessing the target LLM.

In some examples, the updated response receiver 650 may be configured to support receiving, from target LLM associated with the first application, a set of multiple updated responses based on the application-specific LLM prompt of the first application utilizing the set of updated parameters in accordance with a configuration of the first application. In some examples, the updated response transmitter 655 may be configured to support transmitting, to the set of multiple users of the first application and in response to reception of the set of multiple updated responses, the set of multiple updated responses.

In some examples, the LLM training component 660 may be configured to support performing a first training procedure on the first LLM to train the first LLM to evaluate feedback that is associated with respective responses from a respective LLM based on a respective LLM prompt, where the first LLM is configured to evaluate feedback based on the first training procedure. In some examples, the LLM training component 660 may be configured to support performing a second training procedure on the second LLM to train the second LLM to generate summaries, where the second LLM is configured to generate summaries based on the second training procedure. In some examples, the LLM training component 660 may be configured to support performing a third training procedure on the third LLM to train the third LLM to fine-tune LLM prompts associated with applications, where the third LLM is configured to fine-tune LLM prompts based on the third training procedure.

In some examples, the LLM prompt tuning procedure initiation component 665 may be configured to support initiating, after receiving the set of multiple feedback indications associated with the set of multiple responses, an application-specific LLM prompt tuning procedure to update the set of parameters of the application-specific LLM prompt, the application-specific LLM prompt tuning procedure including the transmission of the set of multiple feedback indications, the transmission of the set of multiple feedback evaluations, and the transmission of the summary of the set of multiple feedback evaluations.

In some examples, the feedback indication receiver 625 may be configured to support receiving, from the set of multiple users of the first application, a second set of multiple feedback indications associated with a second set of multiple responses from the target LLM based on the application-specific LLM prompt, the application-specific LLM prompt utilizing the set of updated parameters based on configuring the first application, where a performance metric associated with the second set of multiple feedback indications is less than a performance threshold. In some examples, the LLM prompt tuning procedure initiation component 665 may be configured to support initiating, in response to receiving the second set of multiple feedback indications and the second set of multiple feedback indications being less than the performance threshold, the application-specific LLM prompt tuning procedure, where the application-specific LLM prompt tuning procedure continues until a respective set of multiple feedback indications satisfies the performance threshold.

In some examples, the performance threshold is associated with a threshold quantity of positive feedback indications.

In some examples, to support receiving the set of multiple feedback indications, the feedback indication receiver 625 may be configured to support receiving, from the set of multiple users of the first application, a set of multiple positive feedback indications associated with a first subset of responses of the set of multiple responses and a set of multiple negative feedback indications associated with a second subset of responses of the set of multiple responses, the set of multiple feedback indications including the set of multiple positive feedback indications and the set of multiple negative feedback indications.

In some examples, to support transmitting the set of multiple feedback indications to the first LLM, the feedback indication transmitter 675 may be configured to support transmitting the set of multiple negative feedback indications to the first LLM. In some examples, to support transmitting the set of multiple feedback indications to the first LLM, the feedback indication transmitter 675 may be configured to support refraining from transmitting the set of multiple positive feedback indications to the second LLM.

In some examples, to support transmitting the set of multiple feedback indications to the first LLM, the feedback evaluations acquisition component 630 may be configured to support identifying, in response to receiving the set of multiple feedback indications from the set of multiple users, that a threshold is satisfied. In some examples, to support transmitting the set of multiple feedback indications to the first LLM, the feedback evaluations acquisition component 630 may be configured to support transmitting, to the first LLM, the set of multiple feedback indications based on satisfaction of the threshold.

In some examples, the threshold includes a feedback indication quantity threshold associated with a threshold quantity of feedback indications, a time threshold associated with a threshold quantity of time since an update to the set of parameters of the application-specific LLM prompt, or both.

In some examples, to support transmitting the set of multiple feedback indications and the set of multiple responses to the first LLM, the feedback evaluations acquisition component 630 may be configured to support completing, for each feedback indication and response associated with the feedback indication, a prompt of the first LLM with a data triple including a respective feedback indication, a respective response associated with the respective feedback indication, and the application-specific LLM prompt, where the first LLM is configured to evaluate the feedback based on the prompt of the first LLM and on completion of the prompt of the first LLM.

In some examples, to support transmitting the set of multiple feedback evaluations to the second LLM, the feedback evaluation concatenation component 670 may be configured to support concatenating the set of multiple feedback evaluations into a concatenated feedback evaluation input. In some examples, to support transmitting the set of multiple feedback evaluations to the second LLM, the summary of feedback evaluations acquisition component 635 may be configured to support completing a prompt of the second LLM with the concatenated feedback evaluation input, where the second LLM is configured to generate the summaries based on the prompt of the second LLM and on completion of the prompt of the second LLM.

In some examples, to support transmitting the summary of the set of multiple feedback evaluations to the third LLM, the updated parameters acquisition component 640 may be configured to support completing a prompt of the third LLM with the summary of the set of multiple feedback evaluations, the application-specific LLM prompt, and one or more data triples including a respective feedback indication of the set of multiple feedback indications, a respective response associated with the respective feedback indication of the set of multiple responses, and a respective feedback evaluation of the set of multiple feedback evaluations associated with the respective feedback indication and the respective response, where the third LLM is configured to fine-tune the LLM prompts based on the prompt of the third LLM and on completion of the prompt of the third LLM.

In some examples, the set of multiple users are associated with a first tenant of a set of multiple tenants that utilize the first application.

In some examples, the set of multiple users utilize a set of multiple applications that use respective application-specific LLM prompts for accessing respective target LLMs, the set of multiple applications including the first application that uses the application-specific LLM prompt for accessing the target LLM.

FIG. 7 shows a diagram of a system 700 including a device 705 that supports user-feedback based prompt tuning for AI applications in accordance with aspects of the present disclosure. The device 705 may be an example of or include components of a device 505 as described herein. The device 705 may include components for bi-directional data communications including components for transmitting and receiving communications, such as an LLM prompt tuning service 720, an I/O controller, such as an I/O controller 710, a database controller 715, at least one memory 725, at least one processor 730, and a database 735. These components may be in electronic communication or otherwise coupled (e.g., operatively, communicatively, functionally, electronically, electrically) via one or more buses (e.g., a bus 740).

The I/O controller 710 may manage input signals 745 and output signals 750 for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. In other cases, the I/O controller 710 may represent or interact with a modem, a keyboard, a mouse, a touchscreen, or a similar device. In some cases, the I/O controller 710 may be implemented as part of a processor 730. In some examples, a user may interact with the device 705 via the I/O controller 710 or via hardware components controlled by the I/O controller 710.

The database controller 715 may manage data storage and processing in a database 735. In some cases, a user may interact with the database controller 715. In other cases, the database controller 715 may operate automatically without user interaction. The database 735 may be an example of a single database, a distributed database, multiple distributed databases, a data store, a data lake, or an emergency backup database.

Memory 725 may include random-access memory (RAM) and read-only memory (ROM). The memory 725 may store computer-readable, computer-executable software including instructions that, when executed, cause at least one processor 730 to perform various functions described herein. In some cases, the memory 725 may contain, among other things, a basic I/O system (BIOS) which may control basic hardware or software operation such as the interaction with peripheral components or devices. The memory 725 may be an example of a single memory or multiple memories. For example, the device 705 may include one or more memories 725.

The processor 730 may include an intelligent hardware device (e.g., a general-purpose processor, a digital signal processor (DSP), a central processing unit (CPU), a microcontroller, an application-specific integrated circuit (ASIC), a field-programmable gate array (FPGA), a programmable logic device, a discrete gate or transistor logic component, a discrete hardware component, or any combination thereof). In some cases, the processor 730 may be configured to operate a memory array using a memory controller. In other cases, a memory controller may be integrated into the processor 730. The processor 730 may be configured to execute computer-readable instructions stored in at least one memory 725 to perform various functions (e.g., functions or tasks supporting user-feedback based prompt tuning for AI applications). The processor 730 may be an example of a single processor or multiple processors. For example, the device 705 may include one or more processors 730.

The LLM prompt tuning service 720 may support fine-tuning a LLM prompt in accordance with examples as disclosed herein. For example, the LLM prompt tuning service 720 may be configured to support receiving, from a set of multiple users of a first application that uses an application-specific LLM prompt for accessing a target LLM, a set of multiple feedback indications associated with a set of multiple responses from the target LLM based on the application-specific LLM prompt, where the application-specific LLM prompt includes a set of parameters. The LLM prompt tuning service 720 may be configured to support transmitting, to a first LLM configured to evaluate feedback, the set of multiple feedback indications and the set of multiple responses associated with the set of multiple feedback indications, where transmission of the set of multiple feedback indications results in a set of multiple feedback evaluations generated by the first LLM. The LLM prompt tuning service 720 may be configured to support transmitting, to a second LLM configured to generate summaries, the set of multiple feedback evaluations obtained from the first LLM, where transmission of the set of multiple feedback evaluations results in a summary of the set of multiple feedback evaluations generated by the second LLM. The LLM prompt tuning service 720 may be configured to support transmitting, to a third LLM configured to fine-tune LLM prompts, the summary of the set of multiple feedback evaluations obtained from the second LLM and the application-specific LLM prompt associated with the set of multiple responses, where transmission of the summary of the set of multiple feedback evaluations results in a set of updated parameters for the application-specific LLM prompt. The LLM prompt tuning service 720 may be configured to support configuring the first application to use the application-specific LLM prompt with the set of updated parameters for accessing the target LLM.

By including or configuring the LLM prompt tuning service 720 in accordance with examples as described herein, the device 705 may support techniques for a system to automatically update an application-specific LLM prompt to support an increase in accuracy, reliability, and efficiency of responses from an LLM application while reducing the latency associated with updating the parameters of the application-specific LLM prompt based on user feedback indications.

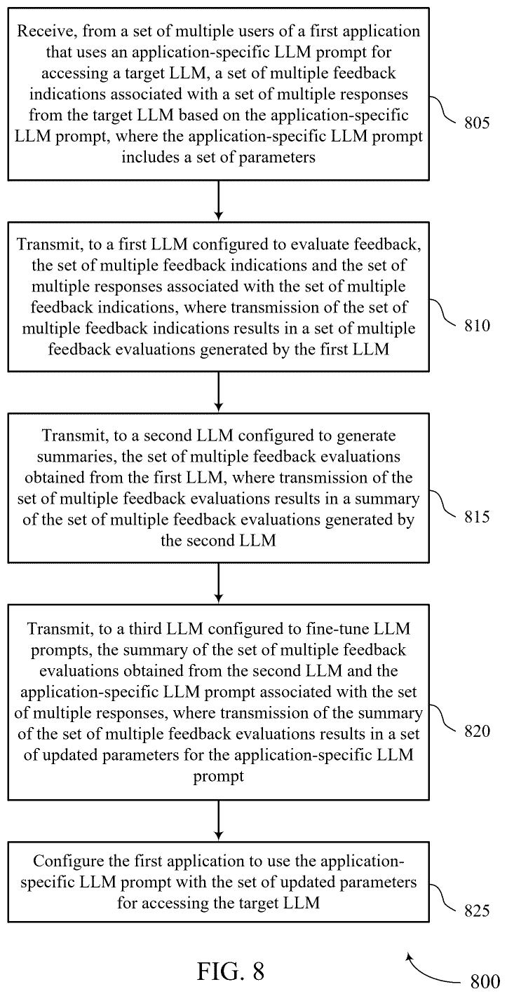

FIG. 8 shows a flowchart illustrating a method 800 that supports user-feedback based prompt tuning for AI applications in accordance with aspects of the present disclosure. The operations of the method 800 may be implemented by a computing device or its components as described herein. For example, the operations of the method 800 may be performed by a computing device as described with reference to FIGS. 1 through 7. In some examples, a computing device may execute a set of instructions to control the functional elements of the computing device to perform the described functions. Additionally, or alternatively, the computing device may perform aspects of the described functions using special-purpose hardware.

At 805, the method may include receiving, from a set of multiple users of a first application that uses an application-specific LLM prompt for accessing a target LLM, a set of multiple feedback indications associated with a set of multiple responses from the target LLM based on the application-specific LLM prompt, where the application-specific LLM prompt includes a set of parameters. The operations of 805 may be performed in accordance with examples as disclosed herein. In some examples, aspects of the operations of 805 may be performed by a feedback indication receiver 625 as described with reference to FIG. 6.

At 810, the method may include transmitting, to a first LLM configured to evaluate feedback, the set of multiple feedback indications and the set of multiple responses associated with the set of multiple feedback indications, where transmission of the set of multiple feedback indications results in a set of multiple feedback evaluations generated by the first LLM. The operations of 810 may be performed in accordance with examples as disclosed herein. In some examples, aspects of the operations of 810 may be performed by a feedback evaluations acquisition component 630 as described with reference to FIG. 6.

At 815, the method may include transmitting, to a second LLM configured to generate summaries, the set of multiple feedback evaluations obtained from the first LLM, where transmission of the set of multiple feedback evaluations results in a summary of the set of multiple feedback evaluations generated by the second LLM. The operations of 815 may be performed in accordance with examples as disclosed herein. In some examples, aspects of the operations of 815 may be performed by a summary of feedback evaluations acquisition component 635 as described with reference to FIG. 6.

At 820, the method may include transmitting, to a third LLM configured to fine-tune LLM prompts, the summary of the set of multiple feedback evaluations obtained from the second LLM and the application-specific LLM prompt associated with the set of multiple responses, where transmission of the summary of the set of multiple feedback evaluations results in a set of updated parameters for the application-specific LLM prompt. The operations of 820 may be performed in accordance with examples as disclosed herein. In some examples, aspects of the operations of 820 may be performed by an updated parameters acquisition component 640 as described with reference to FIG. 6.

At 825, the method may include configuring the first application to use the application-specific LLM prompt with the set of updated parameters for accessing the target LLM. The operations of 825 may be performed in accordance with examples as disclosed herein. In some examples, aspects of the operations of 825 may be performed by a configuration component 645 as described with reference to FIG. 6.

A method for fine-tuning a LLM prompt by an apparatus is described. The method may include receiving, from a set of multiple users of a first application that uses an application-specific LLM prompt for accessing a target LLM, a set of multiple feedback indications associated with a set of multiple responses from the target LLM based on the application-specific LLM prompt, where the application-specific LLM prompt includes a set of parameters, transmitting, to a first LLM configured to evaluate feedback, the set of multiple feedback indications and the set of multiple responses associated with the set of multiple feedback indications, where transmission of the set of multiple feedback indications results in a set of multiple feedback evaluations generated by the first LLM, transmitting, to a second LLM configured to generate summaries, the set of multiple feedback evaluations obtained from the first LLM, where transmission of the set of multiple feedback evaluations results in a summary of the set of multiple feedback evaluations generated by the second LLM, transmitting, to a third LLM configured to fine-tune LLM prompts, the summary of the set of multiple feedback evaluations obtained from the second LLM and the application-specific LLM prompt associated with the set of multiple responses, where transmission of the summary of the set of multiple feedback evaluations results in a set of updated parameters for the application-specific LLM prompt, and configuring the first application to use the application-specific LLM prompt with the set of updated parameters for accessing the target LLM.

An apparatus for fine-tuning a LLM prompt is described. The apparatus may include one or more memories storing processor executable code, and one or more processors coupled with the one or more memories. The one or more processors may individually or collectively be operable to execute the code to cause the apparatus to receive, from a set of multiple users of a first application that uses an application-specific LLM prompt for accessing a target LLM, a set of multiple feedback indications associated with a set of multiple responses from the target LLM based on the application-specific LLM prompt, where the application-specific LLM prompt includes a set of parameters, transmit, to a first LLM configured to evaluate feedback, the set of multiple feedback indications and the set of multiple responses associated with the set of multiple feedback indications, where transmission of the set of multiple feedback indications results in a set of multiple feedback evaluations generated by the first LLM, transmit, to a second LLM configured to generate summaries, the set of multiple feedback evaluations obtained from the first LLM, where transmission of the set of multiple feedback evaluations results in a summary of the set of multiple feedback evaluations generated by the second LLM, transmit, to a third LLM configured to fine-tune LLM prompts, the summary of the set of multiple feedback evaluations obtained from the second LLM and the application-specific LLM prompt associated with the set of multiple responses, where transmission of the summary of the set of multiple feedback evaluations results in a set of updated parameters for the application-specific LLM prompt, and configure the first application to use the application-specific LLM prompt with the set of updated parameters for accessing the target LLM.

Another apparatus for fine-tuning a LLM prompt is described. The apparatus may include means for receiving, from a set of multiple users of a first application that uses an application-specific LLM prompt for accessing a target LLM, a set of multiple feedback indications associated with a set of multiple responses from the target LLM based on the application-specific LLM prompt, where the application-specific LLM prompt includes a set of parameters, means for transmitting, to a first LLM configured to evaluate feedback, the set of multiple feedback indications and the set of multiple responses associated with the set of multiple feedback indications, where transmission of the set of multiple feedback indications results in a set of multiple feedback evaluations generated by the first LLM, means for transmitting, to a second LLM configured to generate summaries, the set of multiple feedback evaluations obtained from the first LLM, where transmission of the set of multiple feedback evaluations results in a summary of the set of multiple feedback evaluations generated by the second LLM, means for transmitting, to a third LLM configured to fine-tune LLM prompts, the summary of the set of multiple feedback evaluations obtained from the second LLM and the application-specific LLM prompt associated with the set of multiple responses, where transmission of the summary of the set of multiple feedback evaluations results in a set of updated parameters for the application-specific LLM prompt, and means for configuring the first application to use the application-specific LLM prompt with the set of updated parameters for accessing the target LLM.

A non-transitory computer-readable medium storing code for fine-tuning a LLM prompt is described. The code may include instructions executable by one or more processors to receive, from a set of multiple users of a first application that uses an application-specific LLM prompt for accessing a target LLM, a set of multiple feedback indications associated with a set of multiple responses from the target LLM based on the application-specific LLM prompt, where the application-specific LLM prompt includes a set of parameters, transmit, to a first LLM configured to evaluate feedback, the set of multiple feedback indications and the set of multiple responses associated with the set of multiple feedback indications, where transmission of the set of multiple feedback indications results in a set of multiple feedback evaluations generated by the first LLM, transmit, to a second LLM configured to generate summaries, the set of multiple feedback evaluations obtained from the first LLM, where transmission of the set of multiple feedback evaluations results in a summary of the set of multiple feedback evaluations generated by the second LLM, transmit, to a third LLM configured to fine-tune LLM prompts, the summary of the set of multiple feedback evaluations obtained from the second LLM and the application-specific LLM prompt associated with the set of multiple responses, where transmission of the summary of the set of multiple feedback evaluations results in a set of updated parameters for the application-specific LLM prompt, and configure the first application to use the application-specific LLM prompt with the set of updated parameters for accessing the target LLM.

Some examples of the method, apparatus, and non-transitory computer-readable medium described herein may further include operations, features, means, or instructions for receiving, from target LLM associated with the first application, a set of multiple updated responses based on the application-specific LLM prompt of the first application utilizing the set of updated parameters in accordance with a configuration of the first application and transmitting, to the set of multiple users of the first application and in response to reception of the set of multiple updated responses, the set of multiple updated responses.

Some examples of the method, apparatus, and non-transitory computer-readable medium described herein may further include operations, features, means, or instructions for performing a first training procedure on the first LLM to train the first LLM to evaluate feedback that may be associated with respective responses from a respective LLM based on a respective LLM prompt, where the first LLM may be configured to evaluate feedback based on the first training procedure, performing a second training procedure on the second LLM to train the second LLM to generate summaries, where the second LLM may be configured to generate summaries based on the second training procedure, and performing a third training procedure on the third LLM to train the third LLM to fine-tune LLM prompts associated with applications, where the third LLM may be configured to fine-tune LLM prompts based on the third training procedure.

Some examples of the method, apparatus, and non-transitory computer-readable medium described herein may further include operations, features, means, or instructions for initiating, after receiving the set of multiple feedback indications associated with the set of multiple responses, an application-specific LLM prompt tuning procedure to update the set of parameters of the application-specific LLM prompt, the application-specific LLM prompt tuning procedure including the transmission of the set of multiple feedback indications, the transmission of the set of multiple feedback evaluations, and the transmission of the summary of the set of multiple feedback evaluations.

Some examples of the method, apparatus, and non-transitory computer-readable medium described herein may further include operations, features, means, or instructions for receiving, from the set of multiple users of the first application, a second set of multiple feedback indications associated with a second set of multiple responses from the target LLM based on the application-specific LLM prompt, the application-specific LLM prompt utilizing the set of updated parameters based on configuring the first application, where a performance metric associated with the second set of multiple feedback indications may be less than a performance threshold and initiating, in response to receiving the second set of multiple feedback indications and the second set of multiple feedback indications being less than the performance threshold, the application-specific LLM prompt tuning procedure, where the application-specific LLM prompt tuning procedure continues until a respective set of multiple feedback indications satisfies the performance threshold.

In some examples of the method, apparatus, and non-transitory computer-readable medium described herein, the performance threshold may be associated with a threshold quantity of positive feedback indications.

In some examples of the method, apparatus, and non-transitory computer-readable medium described herein, receiving the set of multiple feedback indications may include operations, features, means, or instructions for receiving, from the set of multiple users of the first application, a set of multiple positive feedback indications associated with a first subset of responses of the set of multiple responses and a set of multiple negative feedback indications associated with a second subset of responses of the set of multiple responses, the set of multiple feedback indications including the set of multiple positive feedback indications and the set of multiple negative feedback indications.

In some examples of the method, apparatus, and non-transitory computer-readable medium described herein, transmitting the set of multiple feedback indications to the first LLM may include operations, features, means, or instructions for transmitting the set of multiple negative feedback indications to the first LLM and refraining from transmitting the set of multiple positive feedback indications to the second LLM.

In some examples of the method, apparatus, and non-transitory computer-readable medium described herein, transmitting the set of multiple feedback indications to the first LLM may include operations, features, means, or instructions for identifying, in response to receiving the set of multiple feedback indications from the set of multiple users, that a threshold may be satisfied and transmitting, to the first LLM, the set of multiple feedback indications based on satisfaction of the threshold.

In some examples of the method, apparatus, and non-transitory computer-readable medium described herein, the threshold includes a feedback indication quantity threshold associated with a threshold quantity of feedback indications, a time threshold associated with a threshold quantity of time since an update to the set of parameters of the application-specific LLM prompt, or both.

In some examples of the method, apparatus, and non-transitory computer-readable medium described herein, transmitting the set of multiple feedback indications and the set of multiple responses to the first LLM may include operations, features, means, or instructions for completing, for each feedback indication and response associated with the feedback indication, a prompt of the first LLM with a data triple including a respective feedback indication, a respective response associated with the respective feedback indication, and the application-specific LLM prompt, where the first LLM may be configured to evaluate the feedback based on the prompt of the first LLM and on completion of the prompt of the first LLM.

In some examples of the method, apparatus, and non-transitory computer-readable medium described herein, transmitting the set of multiple feedback evaluations to the second LLM may include operations, features, means, or instructions for concatenating the set of multiple feedback evaluations into a concatenated feedback evaluation input and completing a prompt of the second LLM with the concatenated feedback evaluation input, where the second LLM may be configured to generate the summaries based on the prompt of the second LLM and on completion of the prompt of the second LLM.

In some examples of the method, apparatus, and non-transitory computer-readable medium described herein, transmitting the summary of the set of multiple feedback evaluations to the third LLM may include operations, features, means, or instructions for completing a prompt of the third LLM with the summary of the set of multiple feedback evaluations, the application-specific LLM prompt, and one or more data triples including a respective feedback indication of the set of multiple feedback indications, a respective response associated with the respective feedback indication of the set of multiple responses, and a respective feedback evaluation of the set of multiple feedback evaluations associated with the respective feedback indication and the respective response, where the third LLM may be configured to fine-tune the LLM prompts based on the prompt of the third LLM and on completion of the prompt of the third LLM.

In some examples of the method, apparatus, and non-transitory computer-readable medium described herein, the set of multiple users may be associated with a first tenant of a set of multiple tenants that utilize the first application.

In some examples of the method, apparatus, and non-transitory computer-readable medium described herein, the set of multiple users utilize a set of multiple applications that use respective application-specific LLM prompts for accessing respective target LLMs, the set of multiple applications including the first application that uses the application-specific LLM prompt for accessing the target LLM.

The following provides an overview of aspects of the present disclosure:

Aspect 1: A method for fine-tuning a LLM prompt, comprising: receiving, from a plurality of users of a first application that uses an application-specific LLM prompt for accessing a target LLM, a plurality of feedback indications associated with a plurality of responses from the target LLM based on the application-specific LLM prompt, wherein the application-specific LLM prompt comprises a set of parameters; transmitting, to a first LLM configured to evaluate feedback, the plurality of feedback indications and the plurality of responses associated with the plurality of feedback indications, wherein transmission of the plurality of feedback indications results in a plurality of feedback evaluations generated by the first LLM; transmitting, to a second LLM configured to generate summaries, the plurality of feedback evaluations obtained from the first LLM, wherein transmission of the plurality of feedback evaluations results in a summary of the plurality of feedback evaluations generated by the second LLM; transmitting, to a third LLM configured to fine-tune LLM prompts, the summary of the plurality of feedback evaluations obtained from the second LLM and the application-specific LLM prompt associated with the plurality of responses, wherein transmission of the summary of the plurality of feedback evaluations results in a set of updated parameters for the application-specific LLM prompt; and configuring the first application to use the application-specific LLM prompt with the set of updated parameters for accessing the target LLM.

Aspect 2: The method of aspect 1, further comprising: receiving, from target LLM associated with the first application, a plurality of updated responses based at least in part on the application-specific LLM prompt of the first application utilizing the set of updated parameters in accordance with a configuration of the first application; and transmitting, to the plurality of users of the first application and in response to reception of the plurality of updated responses, the plurality of updated responses.

Aspect 3: The method of any of aspects 1 through 2, further comprising: performing a first training procedure on the first LLM to train the first LLM to evaluate feedback that is associated with respective responses from a respective LLM based on a respective LLM prompt, wherein the first LLM is configured to evaluate feedback based at least in part on the first training procedure; performing a second training procedure on the second LLM to train the second LLM to generate summaries, wherein the second LLM is configured to generate summaries based at least in part on the second training procedure; and performing a third training procedure on the third LLM to train the third LLM to fine-tune LLM prompts associated with applications, wherein the third LLM is configured to fine-tune LLM prompts based at least in part on the third training procedure.

Aspect 4: The method of any of aspects 1 through 3, further comprising: initiating, after receiving the plurality of feedback indications associated with the plurality of responses, an application-specific LLM prompt tuning procedure to update the set of parameters of the application-specific LLM prompt, the application-specific LLM prompt tuning procedure comprising the transmission of the plurality of feedback indications, the transmission of the plurality of feedback evaluations, and the transmission of the summary of the plurality of feedback evaluations.

Aspect 5: The method of aspect 4, further comprising: receiving, from the plurality of users of the first application, a second plurality of feedback indications associated with a second plurality of responses from the target LLM based on the application-specific LLM prompt, the application-specific LLM prompt utilizing the set of updated parameters based at least in part on configuring the first application, wherein a performance metric associated with the second plurality of feedback indications is less than a performance threshold; and initiating, in response to receiving the second plurality of feedback indications and the second plurality of feedback indications being less than the performance threshold, the application-specific LLM prompt tuning procedure, wherein the application-specific LLM prompt tuning procedure continues until a respective plurality of feedback indications satisfies the performance threshold.

Aspect 6: The method of aspect 5, wherein the performance threshold is associated with a threshold quantity of positive feedback indications.

Aspect 7: The method of any of aspects 1 through 6, wherein receiving the plurality of feedback indications comprises: receiving, from the plurality of users of the first application, a plurality of positive feedback indications associated with a first subset of responses of the plurality of responses and a plurality of negative feedback indications associated with a second subset of responses of the plurality of responses, the plurality of feedback indications comprising the plurality of positive feedback indications and the plurality of negative feedback indications.

Aspect 8: The method of aspect 7, wherein transmitting the plurality of feedback indications to the first LLM comprises: transmitting the plurality of negative feedback indications to the first LLM; and refraining from transmitting the plurality of positive feedback indications to the second LLM.

Aspect 9: The method of any of aspects 1 through 8, wherein transmitting the plurality of feedback indications to the first LLM comprises: identifying, in response to receiving the plurality of feedback indications from the plurality of users, that a threshold is satisfied; and transmitting, to the first LLM, the plurality of feedback indications based at least in part on satisfaction of the threshold.

Aspect 10: The method of aspect 9, wherein the threshold comprises a feedback indication quantity threshold associated with a threshold quantity of feedback indications, a time threshold associated with a threshold quantity of time since an update to the set of parameters of the application-specific LLM prompt, or both.

Aspect 11: The method of any of aspects 1 through 10, wherein transmitting the plurality of feedback indications and the plurality of responses to the first LLM comprises: completing, for each feedback indication and response associated with the feedback indication, a prompt of the first LLM with a data triple comprising a respective feedback indication, a respective response associated with the respective feedback indication, and the application-specific LLM prompt, wherein the first LLM is configured to evaluate the feedback based at least in part on the prompt of the first LLM and on completion of the prompt of the first LLM.

Aspect 12: The method of any of aspects 1 through 11, wherein transmitting the plurality of feedback evaluations to the second LLM comprises: concatenating the plurality of feedback evaluations into a concatenated feedback evaluation input; and completing a prompt of the second LLM with the concatenated feedback evaluation input, wherein the second LLM is configured to generate the summaries based at least in part on the prompt of the second LLM and on completion of the prompt of the second LLM.

Aspect 13: The method of any of aspects 1 through 12, wherein transmitting the summary of the plurality of feedback evaluations to the third LLM comprises: completing a prompt of the third LLM with the summary of the plurality of feedback evaluations, the application-specific LLM prompt, and one or more data triples comprising a respective feedback indication of the plurality of feedback indications, a respective response associated with the respective feedback indication of the plurality of responses, and a respective feedback evaluation of the plurality of feedback evaluations associated with the respective feedback indication and the respective response, wherein the third LLM is configured to fine-tune the LLM prompts based at least in part on the prompt of the third LLM and on completion of the prompt of the third LLM

Aspect 14: The method of any of aspects 1 through 13, wherein the plurality of users are associated with a first tenant of a plurality of tenants that utilize the first application.

Aspect 15: The method of any of aspects 1 through 14, wherein the plurality of users utilize a plurality of applications that use respective application-specific LLM prompts for accessing respective target LLMs, the plurality of applications comprising the first application that uses the application-specific LLM prompt for accessing the target LLM.

Aspect 16: An apparatus for fine-tuning a LLM prompt, comprising one or more memories storing processor-executable code, and one or more processors coupled with the one or more memories and individually or collectively operable to execute the code to cause the apparatus to perform a method of any of aspects 1 through 15.

Aspect 17: An apparatus for fine-tuning a LLM prompt, comprising at least one means for performing a method of any of aspects 1 through 15.

Aspect 18: A non-transitory computer-readable medium storing code for fine-tuning a LLM prompt, the code comprising instructions executable by one or more processors to perform a method of any of aspects 1 through 15.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for fine-tuning a large language model (LLM) prompt, comprising:
receiving, from a plurality of users of a first application that uses an application-specific LLM prompt for accessing a target LLM, a plurality of feedback indications associated with a plurality of responses from the target LLM based on the application-specific LLM prompt, wherein the application-specific LLM prompt comprises a set of parameters;
transmitting, to a first LLM configured to evaluate feedback, the plurality of feedback indications and the plurality of responses associated with the plurality of feedback indications, wherein transmission of the plurality of feedback indications results in a plurality of feedback evaluations generated by the first LLM;
transmitting, to a second LLM configured to generate summaries, the plurality of feedback evaluations obtained from the first LLM, wherein transmission of the plurality of feedback evaluations results in a summary of the plurality of feedback evaluations generated by the second LLM;
transmitting, to a third LLM configured to fine-tune LLM prompts, the summary of the plurality of feedback evaluations obtained from the second LLM and the application-specific LLM prompt associated with the plurality of responses, wherein transmission of the summary of the plurality of feedback evaluations results in a set of updated parameters for the application-specific LLM prompt; and
configuring the first application to use the application-specific LLM prompt with the set of updated parameters for accessing the target LLM.

2. The method of claim 1, further comprising:
receiving, from target LLM associated with the first application, a plurality of updated responses based at least in part on the application-specific LLM prompt of the first application utilizing the set of updated parameters in accordance with a configuration of the first application; and
transmitting, to the plurality of users of the first application and in response to reception of the plurality of updated responses, the plurality of updated responses.

3. The method of claim 1, further comprising:
performing a first training procedure on the first LLM to train the first LLM to evaluate feedback that is associated with respective responses from a respective LLM based on a respective LLM prompt, wherein the first LLM is configured to evaluate feedback based at least in part on the first training procedure;
performing a second training procedure on the second LLM to train the second LLM to generate summaries, wherein the second LLM is configured to generate summaries based at least in part on the second training procedure; and
performing a third training procedure on the third LLM to train the third LLM to fine-tune LLM prompts associated with applications, wherein the third LLM is configured to fine-tune LLM prompts based at least in part on the third training procedure.

4. The method of claim 1, further comprising:
initiating, after receiving the plurality of feedback indications associated with the plurality of responses, an application-specific LLM prompt tuning procedure to update the set of parameters of the application-specific LLM prompt, the application-specific LLM prompt tuning procedure comprising the transmission of the plurality of feedback indications, the transmission of the plurality of feedback evaluations, and the transmission of the summary of the plurality of feedback evaluations.

5. The method of claim 4, further comprising:
receiving, from the plurality of users of the first application, a second plurality of feedback indications associated with a second plurality of responses from the target LLM based on the application-specific LLM prompt, the application-specific LLM prompt utilizing the set of updated parameters based at least in part on configuring the first application, wherein a performance metric associated with the second plurality of feedback indications is less than a performance threshold; and
initiating, in response to receiving the second plurality of feedback indications and the second plurality of feedback indications being less than the performance threshold, the application-specific LLM prompt tuning procedure, wherein the application-specific LLM prompt tuning procedure continues until a respective plurality of feedback indications satisfies the performance threshold.

6. The method of claim 5, wherein the performance threshold is associated with a threshold quantity of positive feedback indications.

7. The method of claim 1, wherein receiving the plurality of feedback indications comprises:
receiving, from the plurality of users of the first application, a plurality of positive feedback indications associated with a first subset of responses of the plurality of responses and a plurality of negative feedback indications associated with a second subset of responses of the plurality of responses, the plurality of feedback indications comprising the plurality of positive feedback indications and the plurality of negative feedback indications.

8. The method of claim 7, wherein transmitting the plurality of feedback indications to the first LLM comprises:
transmitting the plurality of negative feedback indications to the first LLM; and
refraining from transmitting the plurality of positive feedback indications to the second LLM.

9. The method of claim 1, wherein transmitting the plurality of feedback indications to the first LLM comprises:
identifying, in response to receiving the plurality of feedback indications from the plurality of users, that a threshold is satisfied; and
transmitting, to the first LLM, the plurality of feedback indications based at least in part on satisfaction of the threshold.

10. The method of claim 9, wherein the threshold comprises a feedback indication quantity threshold associated with a threshold quantity of feedback indications, a time threshold associated with a threshold quantity of time since an update to the set of parameters of the application-specific LLM prompt, or both.

11. The method of claim 1, wherein transmitting the plurality of feedback indications and the plurality of responses to the first LLM comprises:
completing, for each feedback indication and response associated with the feedback indication, a prompt of the first LLM with a data triple comprising a respective feedback indication, a respective response associated with the respective feedback indication, and the application-specific LLM prompt, wherein the first LLM is configured to evaluate the feedback based at least in part on the prompt of the first LLM and on completion of the prompt of the first LLM.

12. The method of claim 1, wherein transmitting the plurality of feedback evaluations to the second LLM comprises:
concatenating the plurality of feedback evaluations into a concatenated feedback evaluation input; and
completing a prompt of the second LLM with the concatenated feedback evaluation input, wherein the second LLM is configured to generate the summaries based at least in part on the prompt of the second LLM and on completion of the prompt of the second LLM.

13. The method of claim 1, wherein transmitting the summary of the plurality of feedback evaluations to the third LLM comprises:
completing a prompt of the third LLM with the summary of the plurality of feedback evaluations, the application-specific LLM prompt, and one or more data triples comprising a respective feedback indication of the plurality of feedback indications, a respective response associated with the respective feedback indication of the plurality of responses, and a respective feedback evaluation of the plurality of feedback evaluations associated with the respective feedback indication and the respective response, wherein the third LLM is configured to fine-tune the LLM prompts based at least in part on the prompt of the third LLM and on completion of the prompt of the third LLM

14. The method of claim 1, wherein the plurality of users are associated with a first tenant of a plurality of tenants that utilize the first application.

15. The method of claim 1, wherein the plurality of users utilize a plurality of applications that use respective application-specific LLM prompts for accessing respective target LLMs, the plurality of applications comprising the first application that uses the application-specific LLM prompt for accessing the target LLM.

16. An apparatus for fine-tuning a large language model (LLM) prompt, comprising:
one or more memories storing processor-executable code; and
one or more processors coupled with the one or more memories and individually or collectively operable to execute the code to cause the apparatus to:
receive, from a plurality of users of a first application that uses an application-specific LLM prompt for accessing a target LLM, a plurality of feedback indications associated with a plurality of responses from the target LLM based on the application-specific LLM prompt, wherein the application-specific LLM prompt comprises a set of parameters;
transmit, to a first LLM configured to evaluate feedback, the plurality of feedback indications and the plurality of responses associated with the plurality of feedback indications, wherein transmission of the plurality of feedback indications results in a plurality of feedback evaluations generated by the first LLM;
transmit, to a second LLM configured to generate summaries, the plurality of feedback evaluations obtained from the first LLM, wherein transmission of the plurality of feedback evaluations results in a summary of the plurality of feedback evaluations generated by the second LLM;
transmit, to a third LLM configured to fine-tune LLM prompts, the summary of the plurality of feedback evaluations obtained from the second LLM and the application-specific LLM prompt associated with the plurality of responses, wherein transmission of the summary of the plurality of feedback evaluations results in a set of updated parameters for the application-specific LLM prompt; and
configure the first application to use the application-specific LLM prompt with the set of updated parameters for accessing the target LLM.

17. The apparatus of claim 16, wherein, to transmit the plurality of feedback indications and the plurality of responses to the first LLM, the one or more processors are individually or collectively operable to execute the code to cause the apparatus to:
complete, for each feedback indication and response associated with the feedback indication, a prompt of the first LLM with a data triple comprising a respective feedback indication, a respective response associated with the respective feedback indication, and the application-specific LLM prompt, wherein the first LLM is configured to evaluate the feedback based at least in part on the prompt of the first LLM and on completion of the prompt of the first LLM.

18. The apparatus of claim 16, wherein, to transmit the plurality of feedback evaluations to the second LLM, the one or more processors are individually or collectively operable to execute the code to cause the apparatus to:
concatenate the plurality of feedback evaluations into a concatenated feedback evaluation input; and
complete a prompt of the second LLM with the concatenated feedback evaluation input, wherein the second LLM is configured to generate the summaries based at least in part on the prompt of the second LLM and on completion of the prompt of the second LLM.

19. The apparatus of claim 16, wherein, to transmit the summary of the plurality of feedback evaluations to the third LLM, the one or more processors are individually or collectively operable to execute the code to cause the apparatus to:
complete a prompt of the third LLM with the summary of the plurality of feedback evaluations, the application-specific LLM prompt, and one or more data triples comprising a respective feedback indication of the plurality of feedback indications, a respective response associated with the respective feedback indication of the plurality of responses, and a respective feedback evaluation of the plurality of feedback evaluations associated with the respective feedback indication and the respective response, wherein the third LLM is configured to fine-tune the LLM prompts based at least in part on the prompt of the third LLM and on completion of the prompt of the third LLM 20. A non-transitory computer-readable medium storing code for fine-tuning a large language model (LLM) prompt, the code comprising instructions executable by one or more processors to:
receive, from a plurality of users of a first application that uses an application-specific LLM prompt for accessing a target LLM, a plurality of feedback indications associated with a plurality of responses from the target LLM based on the application-specific LLM prompt, wherein the application-specific LLM prompt comprises a set of parameters;
transmit, to a first LLM configured to evaluate feedback, the plurality of feedback indications and the plurality of responses associated with the plurality of feedback indications, wherein transmission of the plurality of feedback indications results in a plurality of feedback evaluations generated by the first LLM;
transmit, to a second LLM configured to generate summaries, the plurality of feedback evaluations obtained from the first LLM, wherein transmission of the plurality of feedback evaluations results in a summary of the plurality of feedback evaluations generated by the second LLM;
transmit, to a third LLM configured to fine-tune LLM prompts, the summary of the plurality of feedback evaluations obtained from the second LLM and the application-specific LLM prompt associated with the plurality of responses, wherein transmission of the summary of the plurality of feedback evaluations results in a set of updated parameters for the application-specific LLM prompt; and
configure the first application to use the application-specific LLM prompt with the set of updated parameters for accessing the target LLM.
